(19) United States
(12) Patent Application Publication
(10) Pub. No.: US 2025/0283300 A1
(43) Pub. Date: Sep. 11, 2025

(54) WORK MACHINE AND OPERATION SUPPORT SYSTEM

(71) Applicant: SUMITOMO CONSTRUCTION MACHINERY CO., LTD., Tokyo (JP)

(72) Inventors: Yuiki MATSUHASHI, Chiba (JP); Kazuma SHINKAI, Chiba (JP)

(21) Appl. No.: 19/062,536

(22) Filed: Feb. 25, 2025

(30) Foreign Application Priority Data
Mar. 11, 2024 (JP) 2024-037461

(51) Int. Cl. E02F 9/20; E02F 3/32; E02F 9/22; E02F 9/26

(52) U.S. Cl. CPC E02F 9/2033; E02F 9/26; E02F 3/32; E02F 9/205; E02F 9/2203; E02F 9/2285; E02F 9/2292; E02F 9/2296

(57) ABSTRACT

A work machine includes a lower traveling body; an upper slewing body slewably mounted on the lower traveling body; a cabin mounted on the upper slewing body and configured to be boarded by an operator of a work machine; and a processor, and a memory storing instructions that cause the processor to execute a process. The process includes acquiring, from a speech button, a camera, or a microphone, information related to a situation of a conversation between the operator and a person around the work machine; and receiving an output of the speech button, the camera, or the microphone, wherein the receiving includes restricting activation of the work machine when a conversation is being held between the operator and the person around the work machine.

### CROSS-REFERENCE TO RELATED APPLICATIONS

This application is based upon and claims priority to Japanese Patent Application No. 2024-037461, filed on Mar. 11, 2024, the entire contents of which are incorporated herein by reference.

### BACKGROUND

### 1. Technical Field

The present disclosure relates to a work machine and the like.

### 2. Description of Related Art

In some related art technologies, communication is achieved by conversation between an operator of a work machine and a person around the work machine (e.g., a worker, a supervisor or a manager of a work site, or the like).

### SUMMARY

According to an embodiment of the present disclosure, a work machine is provided. The work machine comprising:
a lower traveling body;
an upper slewing body slewably mounted on the lower traveling body;
a cabin mounted on the upper slewing body and configured to be boarded by an operator of a work machine; and
a processor, and a memory storing instructions that cause the processor to execute a process, wherein the process includes
   acquiring, from a speech button, a camera, or a microphone, information related to a situation of a conversation between the operator and a person around the work machine; and
   receiving an output of the speech button, the camera, or the microphone,
   wherein the receiving includes restricting activation of the work machine when a conversation is being held between the operator and the person around the work machine.

According to another embodiment of the present disclosure, an operation support system enabling a conversation between an operator who performs remote control of a work machine and a person around the work machine is provided, wherein the work machine includes a lower traveling body and an upper slewing body slewably mounted on the lower traveling body. The operation support system comprising:
a processor, and a memory storing instructions that cause the processor to execute a process, wherein the process includes
   acquiring, from a speech button, a camera, or a microphone, information related to a situation of a conversation between the operator and the person around the work machine; and
   receiving an output of the speech button, the camera, or the microphone,
   wherein the receiving includes restricting activation of the work machine when a conversation is being held between the operator and the person around the work machine.

### BRIEF DESCRIPTION OF THE DRAWINGS

FIG. 1 is a side view illustrating a configuration example of a work machine.

FIG. 2 is a top view illustrating a configuration example of the work machine.

FIG. 3 is a diagram illustrating an example of a configuration of an external sound collection device and an information transmission device.

FIG. 4 is a block diagram illustrating an example of a configuration example of the work machine.

FIG. 5 is a top view illustrating an inside of a cabin of the work machine.

FIG. 6 is a perspective view illustrating the work machine boarded by an operator and a worker around the work machine.

FIG. 7 is a flowchart schematically illustrating a first example of a conversation support process.

FIG. 8 is a flowchart schematically illustrating the first example of the conversation support process.

FIG. 9 is a diagram illustrating an example of a relationship between an operation amount of an operation device and an operation command output from a controller.

FIG. 10 is a flowchart schematically illustrating a second example of a conversation support process.

FIG. 11 is a flowchart schematically illustrating a third example of a conversation support process.

FIG. 12 is a flowchart schematically illustrating a fifth example of a conversation support process.

FIG. 13 is a top view illustrating another example of a configuration of the work machine.

FIG. 14 is a view illustrating an overview of an example of an operation support system.

### DETAILED DESCRIPTION

In the related art technologies, there is a possibility that sound generated by the work machine hinders successful communication between the operator of the work machine and the person around the work machine.

In view of the above problem, an object of the present disclosure is to provide a technique capable of supporting communication between an operator of a work machine and a person around the work machine.

According to the above-described embodiment, it is possible to support communication between an operator of the work machine and a person around the work machine.

Hereinafter, embodiments of the present disclosure will be described with reference to the accompanying drawings. The embodiments described below are merely examples and do not limit the present disclosure. All features and combinations thereof in the embodiments of the present disclosure are not necessarily essential to the invention. In the drawings, the same or corresponding components are denoted by the same or corresponding reference numerals, and redundant description may be omitted.

A work machine 100 according to an embodiment of the present disclosure is an excavator. The work machine 100 may be a machine other than the excavator, such as a crane, an asphalt finisher, or a forklift. In the illustrated example, the excavator as the work machine 100 is a digging machine including the bucket 6 as an end attachment, but may be an application machine such as a forestry machine including an end attachment other than the bucket 6.

### [Overview of Configuration Example of Work Machine]

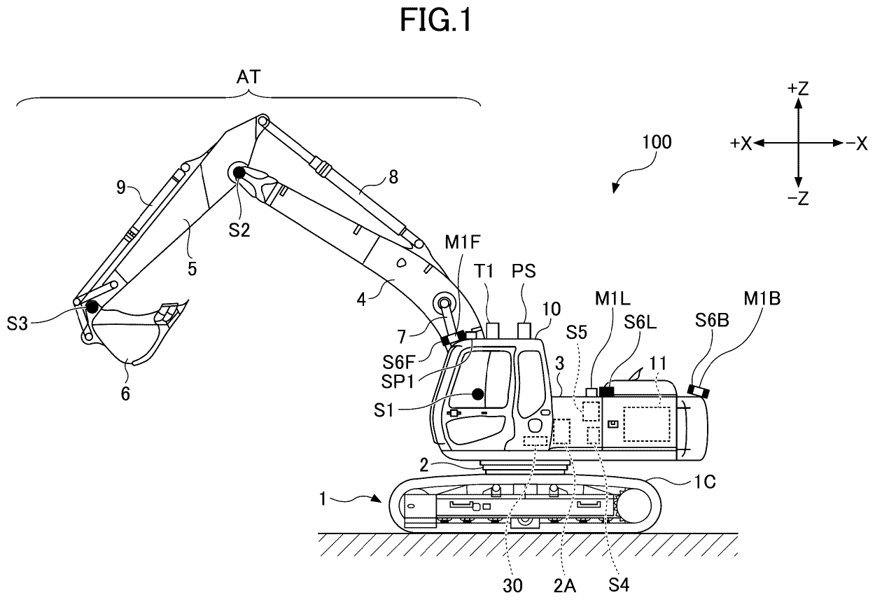

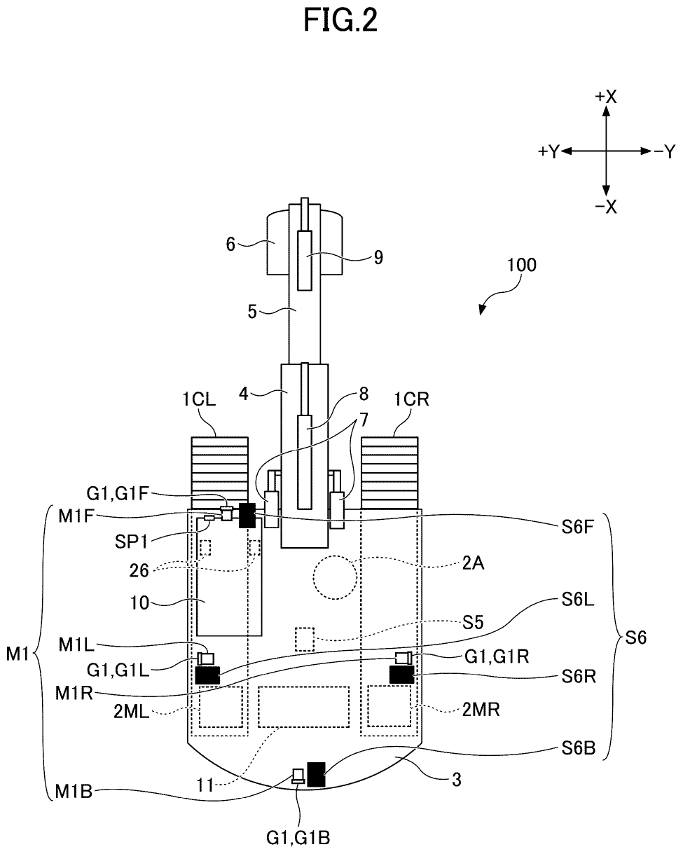

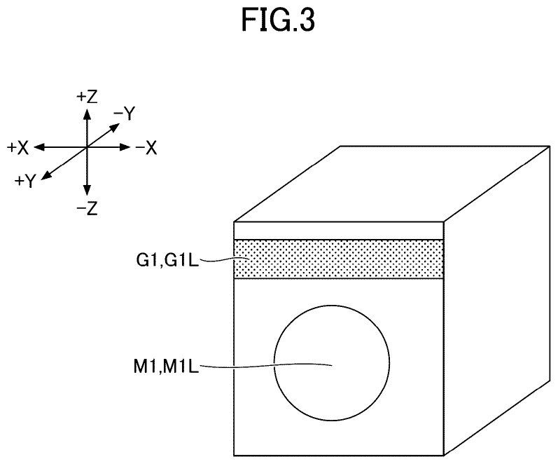

First, an overview of a configuration example of the work machine 100 will be described with reference to FIGS. 1 to 3. FIG. 1 is a side view illustrating a configuration example of the work machine 100. FIG. 2 is a top view illustrating a configuration example of the work machine 100. FIG. 3 is a diagram illustrating an example of a configuration of an external sound collection device M1 and an information transmission device G1. Specifically, FIG. 3 is a perspective view of a left microphone M1L and a left light bar G1L attached to a housing having a substantially rectangular parallelepiped shape.

In FIG. 1, +X represents one direction of the X-axis constituting the three-dimensional orthogonal coordinate system, and −X represents the other direction of the X-axis. In FIG. 2, +Y represents one direction of the Y axis constituting the three-dimensional orthogonal coordinate system, and −Y represents the other direction of the Y axis. In FIG. 1, +Z represents one direction of the Z-axis constituting the three-dimensional orthogonal coordinate system, and −Z represents the other direction of the Z-axis. In FIG. 1, the +X side of the work machine 100 corresponds to the front side of the work machine 100, and the −X side of the work machine 100 corresponds to the rear side of the work machine 100. The +Y side of the work machine 100 corresponds to the left side of the work machine 100, and the −Y side of the work machine 100 corresponds to the right side of the work machine 100. The +Z side of the work machine 100 corresponds to the upper side of the work machine 100, and the −Z side of the work machine 100 corresponds to the lower side of the work machine 100. The same applies to the other drawings.

Further, the following description with reference to FIG. 3 relates to a combination of the left microphone M1L and the left light bar G1L, but is similarly applied to a combination of a front microphone M1F and a front light bar G1F, a combination of a right microphone M1R and a right light bar G1R, and a combination of a rear microphone M1B and a rear light bar G1B.

The work machine 100 includes a lower traveling body 1, an upper slewing body 3 that is slewably mounted on the lower traveling body 1 via a slewing mechanism 2, an attachment AT for performing various kinds of work, and a cabin 10. The cabin 10 is also called a cabin or a cab. The front side of the work machine 100 (upper slewing body 3) corresponds to a side on which the attachment AT is attached to the upper slewing body 3 when the work machine 100 is viewed from directly above along the slewing axis of the upper slewing body 3. The left side, the right side, and the rear side of the work machine 100 (upper slewing body 3) correspond to the left side, the right side, and the rear side, respectively, as viewed from the operator seated on an operator's seat in the cabin 10. The operator is also referred to as an operator.

The lower traveling body 1 includes, for example, a pair of left and right crawlers 1C. In particular, the crawlers 1C include a left crawler 1CL and a right crawler 1CR. The left crawler 1CL is driven by a left traveling hydraulic motor 2ML, and the right crawler 1CR is driven by a right traveling hydraulic motor 2MR. The left traveling hydraulic motor 2ML is a traveling drive part that drives the left crawler 1CL as a driven part, and can rotate the left crawler 1CL. The right traveling hydraulic motor 2MR is a traveling drive part that drives the right crawler 1CR as a driven part, and can rotate the right crawler 1CR. The traveling drive part may be an electric motor.

The upper slewing body 3 slews with respect to the lower traveling body 1 by the slewing mechanism 2 being driven by a slewing hydraulic motor 2A. The slewing hydraulic motor 2A is a slewing drive part that drives the upper slewing body 3 as a driven part, and can change the direction of the upper slewing body 3. The traveling drive part may be an electric motor.

A boom 4 is rotatably attached to the center of the front portion of the upper slewing body 3, an arm 5 is rotatably attached to the distal end of the boom 4, and a bucket 6 is rotatably attached to the distal end of the arm 5. In the illustrated example, the boom 4, the arm 5, and the bucket 6 constitute an excavation attachment which is an example of the attachment AT. The boom 4, the arm 5, and the bucket 6 are driven by a boom cylinder 7, an arm cylinder 8, and a bucket cylinder 9, respectively.

The bucket 6 is an example of a work tool (end attachment). The bucket 6 is used for, for example, excavation work. Instead of the bucket 6, another work tool may be attached to the distal end of the arm 5 according to the work content or the like. The other work tool may be another type of bucket such as a large bucket, a slope bucket, or a dredging bucket. The other work tool may be a work tool of a type other than a bucket, such as a stirrer, a breaker, a grapple, or a lifting magnet.

The slewing hydraulic motor 2A, the left traveling hydraulic motor 2ML, the right traveling hydraulic motor 2MR, the boom cylinder 7, the arm cylinder 8, and the bucket cylinder 9 are hydraulic actuators driven by hydraulic fluid discharged from hydraulic pumps.

In the work machine 100, all or some of the driven parts such as the lower traveling body 1, the upper slewing body 3, the boom 4, the arm 5, and the bucket 6 may be electrically driven. That is, the work machine 100 may be a hybrid work machine, an electric work machine, or the like in which all or some of the driven parts are driven by electric actuators. Hereinafter, when the hydraulic actuator and the electric actuator are not distinguished from each other, they are simply referred to as “actuators”.

Further, the information transmission device G1, the external sound collection device M1, an imaging device S6, and an external sound output device SP1 are attached to the work machine 100.

The imaging device S6 is provided on the upper slewing body 3 or inside the cabin 10, and configured to image the surroundings of the work machine 100 and acquire image information representing the surroundings of the work machine 100. In the illustrated example, the imaging device S6 includes a front camera S6F, a left camera S6L, a right camera S6R, and a rear camera S6B.

The front camera S6F is a camera that images the front of the work machine 100, and is attached to the outside of the cabin 10, such as the roof of the cabin 10 or the side surface of the boom 4. The front camera S6F may be attached to the inside of the cabin 10, for example, the ceiling of the cabin 10. The left camera S6L is a camera that images the left side of the work machine 100, the right camera S6R is a camera that images the right side of the work machine 100, and the rear camera S6B is a camera that images the rear side of the work machine 100. Specifically, each of the front camera S6F, the left camera S6L, the right camera S6R, and the rear camera S6B is a monocular wide-angle camera including an image sensor such as a CCD or a CMOS, and outputs a captured image to a display device D1. Information about the image data captured by the imaging device S6 is taken into a controller 30.

In the illustrated example, the front camera S6F is attached to the roof of the cabin 10, the left camera S6L is attached to the left end of the upper surface of the upper slewing body 3, the right camera S6R is attached to the right end of the upper surface of the upper slewing body 3, and the rear camera S6B is attached to the rear end of the upper surface of the upper slewing body 3.

The imaging device S6 may constitute an object detection device that detects an object around the work machine 100. The object is, for example, a person, an animal, a vehicle, a construction machine, a building, a hole, or the like. The object detection device may be configured to be able to detect a person and an object other than a person in a distinguishable manner. That is, the object detection device may be configured to function as a human detection device. The object detection device may be configured by a device other than a camera. For example, the object detection device may be a light detection and ranging (LiDAR). The LiDAR is, for example, a device capable of measuring a distance between a point group of one million or more points within a monitoring range and the LiDAR (laser source). The object detection device may be another device capable of measuring a distance to the object, such as a stereo camera, a range image camera, or a millimeter wave radar. When a millimeter wave radar or the like is used as the object detection device, the object detection device may derive a distance and direction of the object by transmitting a large number of signals (laser light or the like) toward the object and receiving the reflected signals. Alternatively, the object detection device may be a combination of two or more types of devices. For example, the object detection device may be a combination of an imaging device and a LiDAR, a combination of an imaging device and a millimeter wave radar, or a combination of an imaging device and a stereo camera.

The external sound collection device M1 is a device that collects external sound and is also called a microphone. In the illustrated example, the external sound collection device M1 is provided on the upper slewing body 3 or the cabin 10, converts sound (air vibration) generated around the work machine 100 into mechanical vibration, and converts the mechanical vibration into an electric signal. Specifically, the external sound collection device M1 is configured to be able to pick up voices uttered by workers around the work machine 100, and includes the front microphone M1F, a left microphone M1L, the right microphone M1R, and the rear microphone M1B.

The front microphone M1F is a microphone that collects sound generated in front of the work machine 100, and is attached to the outside of the cabin 10, such as the roof of the cabin 10 or the side surface of the boom 4. The front microphone M1F may be attached to the inside of the cabin 10, for example, the ceiling of the cabin 10. The left microphone M1L is a microphone that collects sound generated on the left side of the work machine 100, the right microphone M1R is a microphone that collects sound generated on the right side of the work machine 100, and the rear microphone M1B is a microphone that collects sound generated on the rear side of the work machine 100. Then, the electric signals generated by the front microphone M1F, the left microphone M1L, the right microphone M1R, and the rear microphone M1B are taken into the controller 30.

In the illustrated example, the front microphone M1F is attached to the roof of the cabin 10, the left microphone M1L is attached to the left end of the upper surface of the upper slewing body 3, the right microphone M1R is attached to the right end of the upper surface of the upper slewing body 3, and the rear microphone M1B is attached to the rear end of the upper surface of the upper slewing body 3. In this way, the four external sound collection devices M1 (the front microphone M1F, the left microphone M1L, the right microphone M1R, and the rear microphone M1B) are provided at different positions of the upper slewing body 5, 3. Therefore, the controller 30 can detect the direction in which the sound generation source is located based on the difference in the sound collected by each of the four external sound collection devices M1 (e.g., the difference in the volume). In addition, when an array microphone is used as the external sound collection device M1, for example, a direction in which a sound generation source is present can be detected based on a phase shift or a difference in sound volume.

In the illustrated example, the four external sound collection devices M1 and the four imaging devices S6 are arranged so as to correspond to each other. Specifically, the front microphone M1F is arranged adjacent to the front camera S6F, the left microphone M1L is arranged adjacent to the left camera S6L, the right microphone M1R is arranged adjacent to the right camera S6R, and the rear microphone M1B is arranged adjacent to the rear camera S6B.

The external sound output device SP1 is a device that outputs sound toward the surroundings of the work machine 100. In the illustrated example, the external sound output device SP1 is a non-directional speaker, and is configured to be able to uniformly output sound in all directions. However, the external sound output device SP1 may be a directional speaker that outputs sound in a specific direction such as forward direction.

The information transmission device G1 is a device that notifies the outside of the work machine 100 of the state of the work machine 100. In the illustrated example, the information transmission device G1 is provided in the upper slewing body 3 or the cabin 10, and is configured to be able to transmit the state of the work machine 100 to a worker around the work machine 100. In particular, the information transmission device G1 is a light emitting device, and includes the front light bar G1F, the left light bar G1L, the right light bar G1R, and the rear light bar G1B.

The front light bar G1F is a light emitting device that can visually convey information to a worker or the like in front of the work machine 100, and is attached to the outside of the cabin 10, such as the roof of the cabin 10 or the side surface of the boom 4. The front light bar G1F may be attached to the inside of the cabin 10, such as the ceiling of the cabin 10. The left light bar G1L is a light emitting device that can visually convey information to a worker or the like on the left side of the work machine 100, the right light bar G1R is a light emitting device that can visually convey information to a worker or the like on the right side of the work machine 100, and the rear light bar G1B is a light emitting device that can visually convey information to a worker or the like on the rear side of the work machine 100. Each of the front light bar G1F, the left light bar G1L, the right light bar G1R, and the rear light bar G1B emits light in response to an electric signal from the controller 30. In the illustrated example, the light emitting device is an LED light, but may be another light emitting device such as a halogen lamp. The light emitting device is a multicolor light emitting type, but may be a monochromatic light emitting type.

In the illustrated example, the front light bar G1F is attached to the roof of the cabin 10, the left light bar G1L is attached to the left end of the upper surface of the upper slewing body 3, the right light bar G1R is attached to the right end of the upper surface of the upper slewing body 3, and the rear light bar G1B is attached to the rear end of the upper surface of the upper slewing body 3. In this way, the four information transmission devices G1 (the front light bar G1F, the left light bar G1L, the right light bar G1R, and the rear light bar G1B) are provided at different positions of the upper slewing body 3. Therefore, the controller 30 can inform a worker or the like in the front, left, right, and rear of the work machine 100 of the state of the work machine 100 by activating the four information transmission devices G1 separately.

In the illustrated example, the four information transmission devices G1 and the four external sound collection devices M1 are arranged so as to correspond to each other. In particular, the front light bar G1F is arranged adjacent to the front microphone M1F, the left light bar G1L is arranged adjacent to the left microphone M1L, the right light bar G1R is arranged adjacent to the right microphone M1R, and the rear light bar G1B is arranged adjacent to the rear microphone M1B.

As illustrated in FIG. 3, the left microphone M1L and the left light bar G1L are disposed on the left side surface of the housing having a substantially rectangular parallelepiped shape so as to face the left side of the work machine 100. With this arrangement, the left microphone M1L can efficiently collect sound generated on the left side of the work machine 100, and the left light bar G1L can efficiently convey the state of the work machine 100 to a worker on the left side of the work machine 100. For example, the left microphone M1L can capture a voice uttered by the worker on the left side of the work machine 100, and the left light bar G1L can notify the worker that the left microphone M1L has captured the voice of the worker by emitting light in a predetermined color. In this case, the worker on the left side of the work machine 100 who talks to the left microphone M1L can confirm that his or her voice has reached the left microphone M1L (i.e., an operator of the work machine 100) by viewing the left light bar G1L that emits light in a predetermined color.

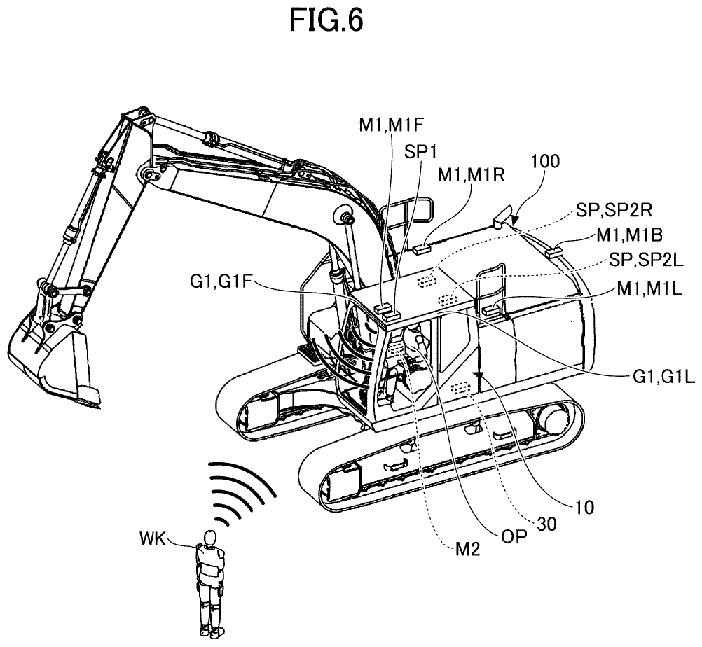

The information transmission device G1 may be provided on an upper portion of each of the four side surfaces of the cabin 10 (see FIG. 6). For example, the information transmission device G1 may be configured such that the front light bar G1F is attached to the upper portion of the front surface of the cabin 10, the left light bar G1L is attached to the upper portion of the left surface of the cabin 10, the right light bar G1R is attached to the upper portion of the right surface of the cabin 10, and the rear light bar G1B is attached to the upper portion of the rear surface of the cabin 10. The information transmission device G1 may be a single rotating light such as a Nicotorch attached to the upper surface of the cabin 10, or may be a display device such as a liquid-crystal display or an organic EL display.

The controller 30 is an example of a control device, and is configured by a computer including a processor such as a central processing unit (CPU), a volatile storage device, a memory such as a nonvolatile storage device, various input/output interfaces, and the like, for example. The controller 30 reads a program from the nonvolatile storage device, loads the program into the volatile storage device, and causes the CPU to execute the program, thereby implementing various functions. In the illustrated example, the controller 30 is configured to be able to control the work machine 100 by implementing various functions. The various functions include, for example, a machine guidance function for guiding a manual operation of the work machine 100 by the operator. The various functions may include a contact avoidance function of automatically or autonomously activating or stopping the work machine 100 in order to avoid contact between the work machine 100 and an object present within the monitoring range around the work machine 100.

Note that some of the functions of the controller 30 may be implemented by another controller. That is, the functions of the controller 30 may be shared by a plurality of controllers. Further, some of the functions of the controller 30 may be implemented by a control device (e.g., a management device 200 described later) outside the work machine 100.

A boom angle sensor S1 detects a boom angle which is a rotation angle of the boom 4 with respect to the upper slewing body 3. An arm angle sensor S2 detects an arm angle which is a rotation angle of the arm 5 with respect to the boom 4. A bucket angle sensor S3 detects a bucket angle that is a rotation angle of the bucket 6 with respect to the arm 5.

The boom angle sensor S1, the arm angle sensor S2, and the bucket angle sensor S3 may be, for example, rotary encoders, accelerometers, six axis sensors, or IMU (Inertial Measurement Unit), or may be potentiometers using variable resistors, or cylinder stroke sensors that detect the stroke amounts of hydraulic cylinders.

A detection signal corresponding to the boom angle by the boom angle sensor S1, a detection signal corresponding to the arm angle by the arm angle sensor S2, and a detection signal corresponding to the bucket angle by the bucket angle sensor S3 are taken into the controller 30.

A body inclination sensor S4 detects an inclination state of the machine (the lower traveling body 1 or the upper slewing body 3) with respect to a horizontal plane. The machine body inclination sensor S4 is attached to, for example, the upper slewing body 3, and detects inclination angles of the work machine 100 (i.e., the upper slewing body 3) around two axes in the front-rear direction and the right-left direction. The body inclination sensor S4 may be, for example, an accelerometer, a six-axis sensor, or an IMU. A detection signal corresponding to the inclination angle by the body inclination sensor S4 is taken into the controller 30.

A slewing sensor S5 outputs information related to the slewing of the upper slewing body 3. The slewing sensor S5 detects, for example, a slewing angular velocity of the upper slewing body 3 with respect to the lower traveling body 1. The slewing sensor S5 may detect a slewing angle. The slewing sensor S5 may be, for example, a gyro sensor, a resolver, or a rotary encoder. A detection signal corresponding to the slewing angle or slewing angular velocity of the upper slewing body 3 by the slewing sensor S5 is taken into the controller 30.

The positioning device PS measures the position of the upper slewing body 3. The positioning device PS is, for example, a global navigation satellite system (GNSS) compass, and detects the position and orientation of the upper slewing body 3. A detection signal corresponding to the position and orientation of the upper slewing body 3 is taken into the controller 30. The function of detecting the orientation of the upper slewing body 3 may be implemented by an orientation sensor attached to the upper slewing body 3.

The cabin 10 is a partitioned space where an operator boards and is provided on the front left side of the upper slewing body 3. However, in a case where the work machine 100 is remotely controlled, or in a case where the work machine 100 is activated by fully automatic driving, the cabin 10 may be omitted.

A communication device T1 communicates with external devices via communication networks including mobile communication networks, satellite communication networks, the Internet networks, and the like. The communication device T1 is, for example, a mobile communication module corresponding to a mobile communication standard such as Long-Term Evolution (LTE), 4G (4th Generation), or 5G (5th Generation), a communication module corresponding to a short-range wireless communication standard such as Wi-Fi (registered trademark) or Bluetooth (registered trademark), or a satellite communications module for connecting to a satellite communications network.

The work machine 100 activates the actuator in response to an operation of an operator getting in the cabin 10, and drives the driven parts such as the lower traveling body 1, the upper slewing body 3, the boom 4, the arm 5, and the bucket 6.

Alternatively, the work machine 100 may be configured to be remotely controlled from the outside of the work machine 100. When the work machine 100 is remotely controlled, the inside of the cabin 10 may be unmanned.

The work machine 100 may automatically activate the actuator independent of the content of the operation by the operator. Thus, the work machine 100 implements a function of automatically activating at least some of the driven parts such as the lower traveling body 1, the upper slewing body 3, the boom 4, the arm 5, and the bucket 6, that is, a so-called “machine control function”.

### [Details of Configuration Example of Work Machine]

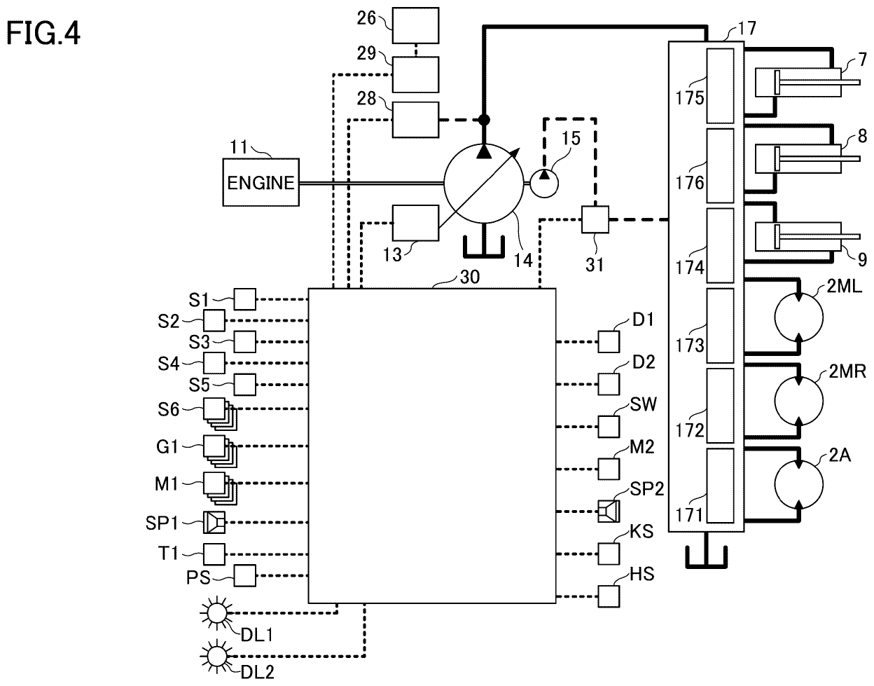

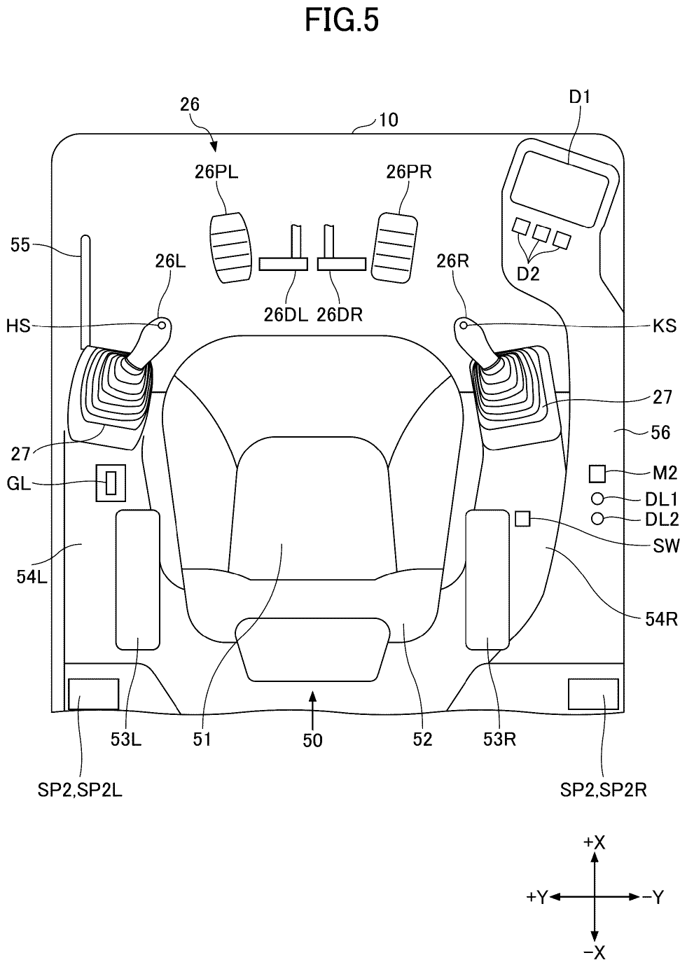

Next, a configuration example of the work machine 100 will be described in detail with reference to FIGS. 4 to 6 in addition to FIGS. 1 to 3. FIG. 4 is a block diagram illustrating an example of a configuration of the work machine 100. In FIG. 4, a mechanical power transmission system, a hydraulic fluid line, a pilot line, and an electric control system are indicated by a double line, a thick solid line, a thick broken line, and a dotted line, respectively. FIG. 5 is a top view illustrating the inside of the cabin 10. FIG. 6 is a perspective view illustrating the work machine 100 where an operator OP boards and a worker WK in front of the work machine 100 on the left. In particular, FIG. 6 illustrates a state in which a voice of the operator OP is collected by an internal sound collection device M2 and output from the external sound output device SP1, and a voice of the worker WK is collected by the external sound collection device M1 and output from an internal sound output device SP2.

The drive system of the work machine 100 includes an engine 11, a regulator 13, a main pump 14, and a control valve unit 17. The hydraulic drive system of the work machine 100 includes hydraulic actuators such as the slewing hydraulic motor 2A, the left traveling hydraulic motor 2ML, the right traveling hydraulic motor 2MR, the boom cylinder 7, the arm cylinder 8, and the bucket cylinder 9.

The engine 11 is an example of a power source of the work machine 100, and is mounted, for example, on a rear portion of the upper slewing body 3. The power source of the work machine 100 may be a combination of a power source such as a battery or a fuel cell and an electric motor. Specifically, the engine 11 rotates at a constant target rotational speed set in advance under direct or indirect control of the controller 30, and drives the main pump 14 and a pilot pump 15. The engine 11 is, for example, a diesel engine using light oil as fuel. The engine 11 may be a gasoline engine, a hydrogen engine, or the like.

The regulator 13 controls the discharge amount of the main pump 14. For example, the regulator 13 controls the discharge amount of the main pump 14 by adjusting the angle (tilting angle) of a swash plate of the main pump 14 in response to a control command from the controller 30.

The main pump 14 is mounted, for example, on the rear portion of the upper slewing body 3 similarly to the engine 11, and supplies the hydraulic fluid to the control valve unit 17 through the hydraulic fluid line. In the illustrated example, the main pump 14 is a variable displacement hydraulic pump.

The control valve unit 17 is one of the hydraulic control devices that control the hydraulic system in the work machine 100. In the illustrated example, the control valve unit 17 includes control valves 171 to 176. The control valve unit 17 is configured to be able to selectively supply the hydraulic fluid discharged by the main pump 14 to one or a plurality of hydraulic actuators through the control valves 171 to 176. The control valves 171 to 176 control the flow rate of the hydraulic fluid flowing from the main pump 14 to the hydraulic actuator and the flow rate of the hydraulic fluid flowing from the hydraulic actuator to the hydraulic fluid tank. The hydraulic actuators include the boom cylinder 7, the arm cylinder 8, the bucket cylinder 9, the left traveling hydraulic motor 2ML, the right traveling hydraulic motor 2MR, and the slewing hydraulic motor 2A. Specifically, the control valve 171 corresponds to the left traveling hydraulic motor 2ML, the control valve 172 corresponds to the right traveling hydraulic motor 2MR, and the control valve 173 corresponds to the slewing hydraulic motor 2A. The control valve 174 corresponds to the bucket cylinder 9, the control valve 175 corresponds to the boom cylinder 7, and the control valve 176 corresponds to the arm cylinder 8.

The pilot pump 15 is an example of a pilot pressure generating device and is configured to be able to supply the hydraulic fluid to the hydraulic control device via a pilot line. In the illustrated example, the pilot pump 15 is a fixed displacement hydraulic pump. However, the pilot pressure generating device may be implemented by the main pump 14. That is, the main pump 14 may have a function of supplying the hydraulic fluid to various hydraulic control devices via the pilot line, in addition to the function of supplying the hydraulic fluid to the control valve unit 17 via the hydraulic fluid line. In this case, the pilot pump 15 may be omitted.

A discharge pressure sensor 28 is configured to detect the discharge pressure of the main pump 14. In the illustrated example, the discharge pressure sensor 28 outputs the detected value to the controller 30.

The operation device 26 is a device used by an operator to operate an actuator. The operation device 26 includes, for example, an operation lever and an operation pedal. The actuator may be a hydraulic actuator or an electric actuator as described above.

The operation sensor 29 is configured to detect the content of an operation performed by the operator using the operation device 26. In the present embodiment, the operation sensor 29 detects the operation direction and the operation amount of the operation device 26 corresponding to each of the actuators, and outputs the detected values to the controller 30. In the illustrated example, the controller 30 can control an opening area of a valve 31 in accordance with the output of the operation sensor 29. The controller 30 supplies the hydraulic fluid discharged from the pilot pump 15 to the pilot port of the corresponding control valve in the control valve unit 17. The pressure of the hydraulic fluid supplied to each of the pilot ports (pilot pressure) is, in principle, a pressure corresponding to the operation direction and the operation amount of the operation device 26 corresponding to each of the hydraulic actuators. In this way, the operation device 26 is configured to be able to supply the hydraulic fluid discharged by the pilot pump 15 to the pilot port of the corresponding control valve in the control valve unit 17.

The valve 31 functioning as a machine control valve is disposed in a conduit connecting the pilot pump 15 and a pilot port of a control valve in the control valve unit 17, and is configured to be able to change a flow passage area of the conduit. In the illustrated example, the valve 31 is an electromagnetic valve that is activated in response to a control command (hereinafter, referred to as an “operation command”) output from the controller 30. Therefore, the controller 30 can adjust the pilot pressure acting on the pilot port of the control valve by the valve 31, independently of the operation of the operation device 26 by the operator.

With this configuration, even when the operator does not perform an operation on a specific operation device 26, the controller 30 can activates the hydraulic actuator corresponding to the specific operation device 26.

As illustrated in FIG. 4, the control system of the work machine 100 includes the controller 30, the display device D1, an input device D2, a horn button HS, a speech button KS, the external sound collection device M1, the internal sound collection device M2, the external sound output device SP1, the internal sound output device SP2, an external volume dial DL1, the internal volume dial DL2, a switch SW, the communication device, and the like. T1

The controller 30 is configured to be able to output a control command to the regulator 13 as necessary and change the discharge amount of the main pump 14. Further, the controller 30 may be configured to perform control related to a machine guidance function for guiding (leading) manual activation of the work machine 100 by the operator through the operation device 26, for example. Further, the controller 30 may be configured to perform control related to a machine control function of automatically supporting manual activation of the work machine 100 by the operator through the operation device 26, for example. Note that some of the functions of the controller 30 may be implemented by another controller (control device). That is, the functions of the controller 30 may be implemented in a distributed manner by a plurality of controllers. For example, the machine guidance function and the machine control function may be implemented by a dedicated controller (control device) Here, the inside of the cabin 10 will be described with reference to FIG. 5. The work machine 100 includes an operator's seat 50, an operation device 26, a display device D1, and the like, which are disposed inside the cabin 10. A door for getting in and out is provided on the left side of the operator's seat 50. The operator can enter the inside of the cabin 10 by opening the entrance door.

The operator's seat 50 is disposed at the center of the cabin 10 in a top view. The operator's seat 50 includes a seat 51 on which an operator sits and a backrest 52. The operator's seat 50 is a reclining seat, and the inclination angle of the backrest 52 is adjustable. A left arm rest 53L is disposed on the left side of the operator's seat 50, and a right arm rest 53R is disposed on the right side of the operator's seat 50. The left arm rest 53L and the right arm rest 53R are rotatably supported by the backrest 52.

A left console 54L is disposed on the left side of the operator's seat 50, and a right console 54R is disposed on the right side of the operator's seat 50. The left console 54L and the right console 54R extend along the front-rear direction. The operator's seat 50 is slidable in the front-rear direction. The operator's seat 50 may be configured to be slidable in the front-rear direction together with the left console 54L and the right console 54R.

The left arm rest 53L is disposed on the left console 54L. The right arm rest 53R is disposed on the right console 54R. The left arm rest 53L is disposed so as to cover a part of the left console 54L in a top view. The right arm rest 53R is disposed so as to cover a part of the right console 54R in a top view.

The operation device 26 includes a left operation lever 26L, a right operation lever 26R, a left traveling pedal 26PL, a right traveling pedal 26PR, a left traveling lever 26DL, and a right traveling lever 26DR. The left operation lever 26L is provided at a front portion of the left console 54L. Similarly, the right operation lever 26R is provided at a front portion of the right console 54R. The operator seated on the operator's seat 50 can operate the left operation lever 26L while gripping the left operation lever 26L with the left hand, and can operate the right operation lever 26R while gripping the right operation lever 26R with the right hand. The operator seated on the operator's seat 50 can operate the left operation lever 26L with the left hand to drive the arm cylinder 8 and the slewing hydraulic motor 2A. The operator seated on the operator's seat 50 can operate the right operation lever 26R with the right hand to drive the boom cylinder 7 and the bucket cylinder 9. The base portions of the left operation lever 26L and the right operation lever 26R are covered with lever boots 27.

The left traveling pedal 26PL and the right traveling pedal 26PR are disposed on the floor surface in front of the operator's seat 50. The operator seated on the operator's seat 50 can operate the left traveling pedal 26PL with his/her left foot to drive the left traveling hydraulic motor 2ML. The operator seated on the operator's seat 50 can operate the right traveling pedal 26PR with the right foot to drive the right traveling hydraulic motor 2MR.

The left traveling lever 26DL and the right traveling lever 26DR are disposed between the left traveling pedal 26PL and the right traveling pedal 26PR in a top view. The left traveling lever 26DL and the right traveling lever 26DR extend upward from the floor surface in front of the operator's seat 50. The operator seated on the operator's seat 50 can drive the left traveling hydraulic motor 2ML by operating the left traveling lever 26DL while gripping the left traveling lever 26DL with the left hand, similarly to the operation via the left traveling pedal 26PL. Further, the operator seated on the operator's seat 50 can drive the right traveling hydraulic motor 2MR by operating the right traveling lever 26DR while gripping the right traveling lever 26DR with the right hand, similarly to the operation via the right traveling pedal 26PR. The left traveling lever 26DL and the right traveling lever 26DR are arranged so that the operator can operate the left traveling lever 26DL and the right traveling lever 26DR simultaneously with one hand.

The display device D1 is provided at a position in the cabin 10 where the display device D1 is easily visible to the seated operator, and displays various information images under the control of the controller 30. In the illustrated example, the display device D1 is disposed on the right front side of the operator's seat 50 and is connected to the controller 30 via a dedicated line. The display device D1 displays various kinds of image information. The display device D1 includes a display screen that displays information such as work conditions or activation states of the work machine 100. The operator seated on the operator's seat 50 can perform work with the work machine 100 while checking various information displayed on the display device D1. The display device D1 may be provided with the input device D2.

The input device D2 is provided within reach of the operator seated on the operator's seat 50, receives various operation inputs from the operator, and outputs signals corresponding to the operation inputs to the controller 30. The input device D2 includes a touch panel mounted on a display of the display device D1 that displays various information images, a knob switch provided at a tip of one or more lever portions of a plurality of operation levers included in the operation device 26, or a button switch, a lever, a toggle switch, a rotary dial, or the like installed around the display device D1. A signal corresponding to the content of the operation on the input device D2 is taken into the controller 30.

A gate bar 55 is attached to the front surface of the front-end portion of the left console 54L. The gate bar 55 is activated in conjunction with an operation state of a gate lock lever GL provided on the left console 54L. The gate bar 55 is attached to a frame inside the left console 54L, which can be raised and lowered around an axis extending in the left-right direction at the upper end portion.

The gate lock lever GL is a mechanical input operation part for switching between a state in which the work machine 100 can be operated by the operation device 26 (operable state) and a state in which the work machine 100 cannot be operated by the operation device 26 (inoperable state). In the illustrated example, the gate lock lever GL is configured such that the operator can switch between a first operation position for implementing the inoperable state and a second operation position for implementing the operable state. The controller 30 switches between the operable state and the inoperable state in accordance with the operation state of the gate lock lever GL. In the illustrated example, the controller 30 electrically switches the pilot line between a communication state and a non-communication state in accordance with the operation state of the gate lock lever GL, thereby switching the work machine 100 between the operable state and the inoperable state.

When the gate lock lever GL is in the second operation position, the gate bar 55 is in a state of being raised forward so as to prevent the operator from passing through the entrance door (passing prohibition state), as illustrated in FIG. 5. On the other hand, when the gate lock lever GL is in the first operation position, the gate bar 55 is accommodated in the left console 54L so as not to hinder the operator from passing through the entrance door (passing permission state).

With this configuration, the operator cannot operate the work machine 100 unless the gate lock lever GL is set to the second operation position to set the gate bar 55 to the passing prohibition state. Therefore, this configuration can prevent the work machine 100 from moving unintentionally even when the operator touches the operation device 26 inadvertently when getting in and out. Therefore, this configuration can improve the safety of the work machine 100.

The work machine 100 may be configured to be able to receive a predetermined operation for starting the engine 11 only when the gate lock lever GL is in the second operation position and the gate bar 55 is in the passing prohibition state. That is, the work machine 100 may be configured such that the engine 11 cannot be started when the gate lock lever GL is in the first operation position and the gate bar 55 is in the passing permission state.

The switch SW is provided on the right console 54R. A window side console 56 is installed on the right side of the right console 54R. The window side console 56 extends over the entire length of the cabin 10 in the front-rear direction, and is provided so as to be parallel to the right console 54R. The display device D1 is installed at the front portion of the window side console 56. The window side console 56 is provided with the external volume dial DL1, an internal volume dial DL2, an internal sound collection device M2, a radio tuner, and the like. The radio tuner or the like may be installed on the left console 54L or the right console 54R.

The internal sound collection device M2 is a device that collects sound generated in the cabin 10. In the illustrated example, the internal sound collection device M2 is an indoor microphone, and is configured to be able to pick up voices uttered by the operator in the cabin 10.

The horn button HS is a button operated by the operator of the work machine 100 when sounding a horn sound. In the illustrated example, the horn button HS is a knob switch provided at the distal end of the left operation lever 26L.

The speech button KS is a button operated by the operator of the work machine 100 when the operator of the work machine 100 speaks to a worker around the work machine 100. In the illustrated example, the speech button KS is a knob switch provided at the tip of the right operation lever 26R.

The internal sound output device SP2 is a device that outputs sound toward the operator in the cabin 10, and is provided in the cabin 10. The internal sound output device SP2 converts an electric signal input from the controller 30 into a physical sound (vibration of air) and outputs the physical sound. The internal sound output device SP2 may be provided at any position, and may be provided, for example, in the vicinity of the display device D1, in the vicinity of the input device D2, or in the vicinity of the entrance door of the cabin 10. In the illustrated example, the internal sound output device SP2 includes a left indoor speaker SP2L attached to an upper left corner of the rear wall of the cabin 10 and a right indoor speaker SP2R attached to an upper right corner of the rear wall of the cabin 10. The internal sound output device SP2 may be a headphone or an earphone worn by the operator. In this case, the headphone or earphone is connected to the controller 30 via, for example, Bluetooth (registered trademark) so as to be able to communicate with the controller 30.

The external volume dial DL1 is configured to adjust the volume of the sound output by the external sound output device SP1. The volume of the sound output by each speaker of the external sound output device SP1 may be additionally adjusted by using a device other than the external volume dial DL1, such as a touch panel attached to the display device D1.

The external volume dial DL1 may be configured to be infinitely rotatable in each of the clockwise and counterclockwise directions. This is because the present disclosure can handle a case where the volume adjustment using the external volume dial DL1 and the volume adjustment using a device other than the external volume dial DL1 are used together.

The internal volume dial DL2 is configured to adjust the volume of the sound output by the internal sound output device SP2. The volume of the sound output from each of the internal sound output devices SP2 may be additionally adjusted by using a device other than the internal volume dial DL2, such as a touch panel attached to the display device D1.

The internal volume dial DL2 may be configured to be infinitely rotatable in each of the clockwise and counterclockwise directions. This is because it is possible to handle a case where the volume adjustment using the internal volume dial DL2 and the volume adjustment using a device other than the internal volume dial DL2 are performed together.

The switch SW is an example of an operation tool for switching the activation state of the conversation function. In the illustrated example, the switch SW is provided on the upper surface of the right console 54R. However, the switch SW may be one of the input devices D2, may be implemented by a touch panel provided on the display device D1, or may be a knob switch.

The conversation function is a function for implementing a conversation between the operator OP of the work machine 100 and a person such as the worker WK around the work machine 100 as illustrated in FIG. 6. In the work machine 100 illustrated in FIG. 6, the information transmission device G1 is provided at the upper portion of each of the four side surfaces of the cabin 10. The front light bar G1F provided at the upper portion of the front surface of the cabin 10 emits green light, and the left light bar G1L provided at the upper portion of the left surface of the cabin 10 emits white light. In FIG. 6, a dot pattern is given to the front light bar G1F emitting green light. The worker WK who sees the front light bar G1F emitting green light can recognize that his or her voice is detected by the front microphone M1F. In FIG. 6, other devices such as the imaging device S6 are not illustrated for the sake of clarity.

The activation state of the conversation function includes an ON state (state illustrated in FIG. 6) in which a conversation between the operator OP and the worker WK is possible, and an OFF state in which a conversation between the operator OP and the worker WK is not possible. However, the activation state of the conversation function may additionally include at least one of a hearable state (related to the operator OP) in which the operator OP can hear a voice of the worker WK but the worker WK cannot hear a voice of the operator OP, and an utterable state (related to the operator OP) in which the operator WK can hear the voice of the operator OP but the operator OP cannot hear the voice of the worker WK.

In detail, when the activation state of the conversation function is switched to the ON state by operating the switch SW, the external sound collection device M1, the external sound output device SP1, the internal sound collection device M2, and the internal sound output device SP2 are in an available state. When the switch SW is operated and the activation state of the conversation function is switched to the OFF state, the external sound collection device M1, the external sound output device SP1, the internal sound collection device M2, and the internal sound output device SP2 are in the unavailable state. When the switch SW is operated to switch the activation state of the conversation function to the hearable state, the external sound collection device M1 and the internal sound output device SP2 are brought into the available state. When the switch SW is operated to switch the activation state of the conversation function to the utterable state, the external sound output device SP1 and the internal sound collection device M2 are enabled. In the illustrated example, the operator OP can speak to the worker WK using the external sound output device SP1 by speaking while pressing the speech button KS when the internal sound collection device M2 is in the available state.

Further, when the internal sound collection device M2 is available, the controller 30 may automatically recognize the utterance of the operator OP to the worker WK by applying a known voice recognition process or natural language processing based on the outputs (collected sound) of the internal sound collection device M2. When recognizing the utterance of the worker WK by the operator OP, the controller 30 outputs the voice of the operator OP collected by the internal sound collection device M2 from the external sound output device SP1. Thus, the operator OP can speak to the worker WK using the external sound output device SP1 by simply starting utterance at a timing at which the operator OP wants to speak.

For example, the controller 30 uses a machine learning-based discriminator that recognizes a voice from the output of the internal sound collection device M2, and discriminates whether the recognized voice corresponds to the utterance of the operator OP to the worker WK. The data representing the recognized feature of the voice data is, for example, data of a frequency spectrum or data of a sentence obtained by natural language processing. The discriminator is mainly configured by, for example, a deep neural network (DNN). The discriminator is then obtained by performing supervised learning on the basic training model based on a training dataset. The discriminator may also be obtained by additional training or retraining of an already trained model based on a training dataset. In this case, for example, the discriminator as a trained model is optimized by applying a backpropagation algorithm based on the output error with the training data. The trained model corresponding to the discriminator is distributed from, for example, a predetermined external device (e.g., a management device 200 to be described later) and installed in the controller 30. The discriminator may be, for example, a support vector machine (SVM).

### [First Example of Conversation Support Process]

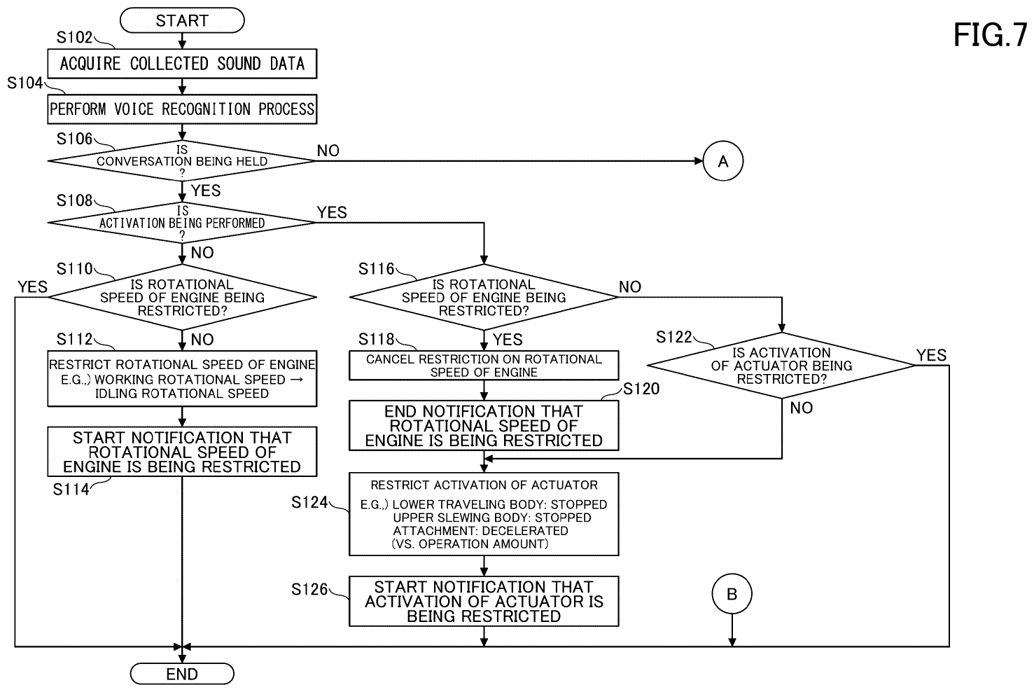

Next, a first example of a control process (hereinafter, a “conversation support process” for convenience) related to support of a conversation between an operator inside the cabin 10 of the work machine 100 and a person around the work machine 100 by the conversation function described above will be described with reference to FIGS. 7 to 9.

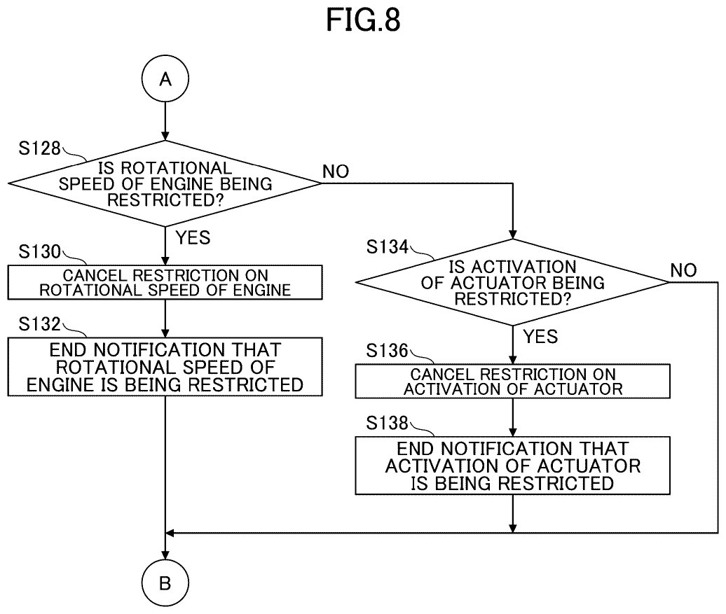

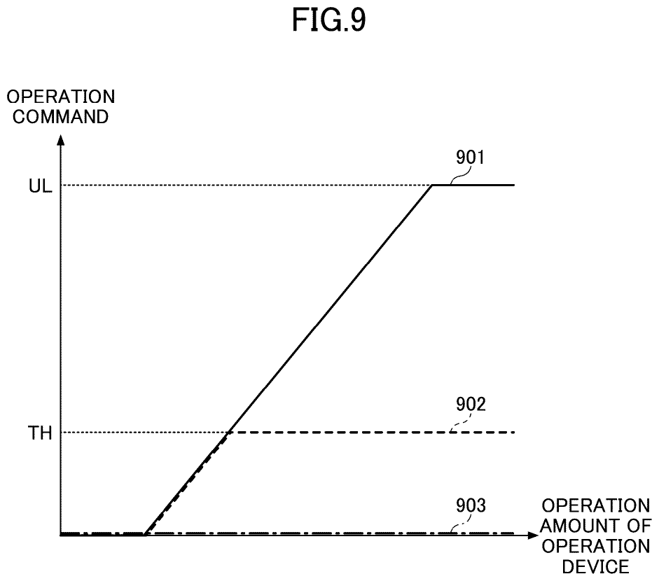

FIGS. 7 and 8 are flowcharts schematically illustrating a first example of the conversation support process. FIG. 9 is a diagram illustrating an example of a relationship between the operation amount of the operation device 26 and the operation command output from the controller 30.

The flowcharts of FIGS. 7 and 8 are repeatedly executed at predetermined control periods, for example, when the activation state of the conversation function is the ON state, the utterable state, or the hearable state. Further, FIG. 9 includes a graph 901 of a normal state in which the activation of the actuator is not restricted, and graphs 902 and 903 of a first example and a second example in which the activation of the actuator is restricted, with respect to a relationship between the operation amount of the operation device 26 and the operation command output from the controller 30.

As illustrated in FIG. 7, in step S102, the controller 30 acquires the latest data (collected sound data) output from at least one sound collection device in an available state, from among the external sound collection device M1 and the internal sound collection device M2.

When the process of step S102 is completed, the controller 30 proceeds to step S104.

In step S104, the controller 30 performs a predetermined voice recognition process for detecting a conversation between the operator in the cabin 10 and the person around the work machine 100 based on the voice acquired in step S102.

When the process of step S104 is completed, the controller 30 proceeds to step S106.

In step S106, the controller 30 determines whether or not a conversation is being held between the operator inside the cabin 10 and the person around the work machine 100, based on the result of the voice recognition process in step S104.

For example, in step S104, the controller 30 performs a known voice recognition process for recognizing a human voice. Then, in step S106, when the controller 30 recognizes a voice of a person, the controller 30 determines that a conversation is being held between the operator inside the cabin 10 and a person around the work machine 100. On the other hand, when the controller 30 does not recognize the voice of the person, the controller 30 determines that the conversation between the operator inside the cabin 10 and the person around the work machine 100 is not being held.

Further, the controller 30 may perform a known voice recognition process from the collected sound data, and when recognizing a voice of a person, determine whether or not the voice corresponds to a conversation. Then, in step S106, when the recognized voice corresponds to a conversation, the controller 30 determines that a conversation is being held between the operator inside the cabin 10 and a person around the work machine 100. On the other hand, when the recognized voice does not correspond to a conversation, the controller 30 determines that a conversation is not being held between the operator inside the cabin 10 and a person around the work machine 100.

For example, the controller 30 performs frequency analysis of the recognized voice data, and determines whether the recognized voice corresponds to a conversation using a predetermined determination criterion based on the features of the frequency spectrum. The controller 30 may perform a known natural language processing (e.g., morphological analysis) based on the recognized voice data and determine whether a sentence obtained by the natural language processing corresponding to the recognized voice corresponds to the conversation using the predetermined determination criterion. The controller 30 may use a machine learning-based discriminator that receives the recognized voice data or data representing the features of the recognized voice data as an input and discriminates whether the recognized voice corresponds to the conversation. The data representing the recognized feature of the voice data is, for example, data of a frequency spectrum or data of a sentence obtained by natural language processing. The discriminator is mainly configured by, for example, a deep neural network (DNN). The discriminator is obtained by performing supervised learning on the basic training model based on the training data set. The discriminator may be obtained by additionally training or retraining a trained model that has been learned based on the training data set. At this time, for example, the algorithm of the backpropagation is applied based on the output error with the training data, and thus the discriminator as the trained model is optimized. The trained model corresponding to the discriminator is distributed from, for example, a predetermined external device (e.g., a management device 200 to be described later) and installed in the controller 30. The discriminator may be, for example, a support vector machine (SVM).

The controller 30 proceeds to step S108 when a conversation is being held between the operator inside the cabin 10 and the person around the work machine 100, and proceeds to step S128 as illustrated in FIG. 8 when the conversation is not being held.

In step S108, the controller 30 determines whether or not an operation of the actuator (i.e., a driven part) is being performed by the operator inside the cabin 10. For example, the controller 30 determines whether or not the operation device 26 is operated based on the output of the operation sensor 29. The controller 30 proceeds to step S110 when the actuator is not operated by the operator inside the cabin 10, and proceeds to step S116 when the actuator is operated.

In step S110, the controller 30 determines whether the rotational speed of the engine 11 is being restricted, according to the previous process or a process performed earlier than the previous process (specifically, a process in step S112 described later) of the flowchart. When the rotational speed of the engine 11 is not being restricted, the controller 30 proceeds to step S112. When the rotational speed of the engine 11 is being restricted, the controller 30 maintains the state and ends the process of the flowchart of this time.

In step S112, the controller 30 restricts the rotational speed of the engine 11. For example, the controller 30 reduces the rotational speed of the engine 11 to a predetermined rotational speed lower than a normal rotational speed, and restricts the rotational speed to that predetermined rotational speed. The normal rotational speed is, for example, a working rotational speed (a rotational speed for work) used when the work machine 100 activates the actuator to perform work. The predetermined rotational speed lower than the normal rotational speed is, for example, an idling rotational speed (rotational speed for idling) used in a state where the work machine 100 is on standby without performing work by activating the actuator.

Thus, the controller 30 can reduce the level of noise caused by the activation of the engine 11 when a conversation is being held between the operator inside the cabin 10 and a person around the work machine 100 in a situation where the operation of the actuator is not being performed by the operator. Therefore, the controller 30 can avoid a situation in which the operator inside the cabin 10 and the person around the work machine 100 cannot communicate with each other by conversation due to the noise of the engine 11.

When the process of step S112 is completed, the controller 30 proceeds to step S114.

In step S114, the controller 30 starts notifying the operator that the rotational speed of the engine 11 is being restricted.

This enables the operator inside the cabin 10 to recognize that the rotational speed of the engine 11 is being restricted. The notification that the rotational speed of the engine 11 is being restricted is given by a visual method through the display device D1, for example. The notification that the rotational speed of the engine 11 is being restricted may be given through predetermined lighting such as an indicator lamp. The notification that the rotational speed of the engine 11 is being restricted may be given by an auditory method through the internal sound output device SP2 or the like, instead of or in addition to the visual method. In addition to the fact that the rotational speed of the engine 11 is being restricted, the controller 30 may notify the operator inside the cabin 10 of the reason therefor. That is, the controller 30 may notify the operator inside the cabin 10 that the rotational speed of the engine 11 is restricted, as a function for supporting a conversation between the operator inside the cabin 10 and a person around the work machine 100.

When the process of step S114 is completed, the controller 30 ends the process of the flowchart of this time.

In step S116, the controller 30 determines whether or not the rotational speed of the engine 11 is being restricted, according to the previous process or a process performed earlier than the previous process of the flowchart (specifically, the process of step S112). When the rotational speed of the engine 11 is being restricted, the controller 30 determines that the operation of the actuator has been started in a state where the rotational speed of the engine 11 is restricted, and proceeds to step S118. When the rotational speed of the engine 11 is not being restricted, the controller 30 proceeds to step S122.

In step S118, the controller 30 cancels the restriction on the rotational speed of the engine 11 that is being executed in the previous process or a process performed earlier than the previous process of the flowchart (specifically, the process of step S112). For example, the controller 30 restores the rotational speed of the engine 11 from the idling rotational speed to the working rotational speed. Thus, the work machine 100 can appropriately activate the hydraulic actuator by the hydraulic fluid supplied from the main pump 14 driven by the engine 11 in response to the operation on the operation device 26.

When the process of step S118 is completed, the controller 30 proceeds to step S120.

In step S120, the controller 30 ends the notification that the rotational speed of the engine 11 is being restricted, which has started in the previous process or a process performed earlier than the previous process of the flowchart (specifically, the process of step S114). The controller 30 may end the notification that the rotational speed of the engine 11 is being restricted and may also provide a notification that the restriction on the rotational speed of the engine 11 has been cancelled.

When the process of step S120 is completed, the controller 30 proceeds to step S124.

In step S122, the controller 30 determines whether or not the activation of the actuator is being restricted, according to the previous process or a process performed earlier than the previous process of this flowchart (specifically, the process of step S124 described later).

When the activation of the actuator is not being restricted, the controller 30 proceeds to step S124. When the activation of the actuator is being restricted, the controller 30 maintains the state and ends the process of the flowchart of this time.

In step S124, the controller 30 restricts the activation of the actuator that drives the work machine 100. The actuator that drives the work machine 100 includes, for example, the left traveling hydraulic motor 2ML, the right traveling hydraulic motor 2MR, the slewing hydraulic motor 2A, the boom cylinder 7, the arm cylinder 8, and the bucket cylinder 9. Thus, the controller 30 can reduce noise caused by the operation of the driven part driven by the actuator when a conversation is being held between the operator inside the cabin 10 and a person around the work machine 100 in a situation where the actuator is being operated. Therefore, the controller 30 can avoid a situation in which the operator inside the cabin 10 and the person around the work machine 100 cannot communicate with each other by conversation due to noise caused by the operation of the driven part.

For example, the controller 30 stops the actuator corresponding to the lower traveling body 1 (specifically, the left traveling hydraulic motor 2ML and the right traveling hydraulic motor 2MR) independent of the operation state. Thus, the controller 30 can stop the lower traveling body 1 or maintain the stopped state of the lower traveling body 1. In this case, for example, as illustrated in FIG. 9, the controller 30 outputs an operation command of zero independent of the operation amount for the left traveling hydraulic motor 2ML and the right traveling hydraulic motor 2MR in the operation device 26 (see the graph 903 in the drawing). Therefore, the controller 30 can prevent noise caused by the operation of the lower traveling body 1, specifically, can prevent the noise from being generated.

Further, for example, the controller 30 stops the actuator (specifically, the slewing hydraulic motor 2A) corresponding to the upper slewing body 3 independent of the operation state. Thus, the controller 30 can stop the upper slewing body 3 or maintain the stopped state of the upper slewing body 3. In this case, for example, as illustrated in FIG. 9, the controller 30 outputs an operation command of zero independent of the operation amount of the operation device 26 with respect to the slewing hydraulic motor 2A (see the graph 903 in the drawing). Therefore, the controller 30 can prevent noise caused by the operation of the upper slewing body 3, specifically, can prevent the generation of noise.

Further, for example, the controller 30 decelerates the activation of the actuator corresponding to the attachment AT (specifically, each of the boom cylinder 7, the arm cylinder 8, and the bucket cylinder 9) with respect to the operation amount of the operation device 26 to a certain speed. In this case, for example, as illustrated in FIG. 9, the controller 30 restricts the operation command to a certain threshold value TH or less (see the graph 902 in the drawing), which is lower than the upper limit UL at normal time (see the graph 901 in the drawing) for each of the boom cylinder 7, the arm cylinder 8, and the bucket cylinder 9. Thus, the controller 30 can reduce the activation speed of the driven part with respect to the same operation amount of the operation device 26 in a range of the operation amount of the operation device 26 in which the operation command is equal to or greater than the threshold value TH (specifically, in a range in which the operation amount is relatively large), as compared to the normal time (i.e., the non-restricted time). Therefore, the controller 30 can prevent noise caused by the operation of the boom 4, the arm 5, and the bucket 6 (specifically, reduce the noise as compared to the normal time corresponding to the graph 901).

When the process of step S124 is completed, the controller 30 proceeds to step S126.

In step S126, the controller 30 starts notification that the activation of the actuator is being restricted.

Thus, the operator in the cabin 10 can recognize that the activation of the actuator is being restricted. The notification that the activation of the actuator is being restricted is performed by a visual method through the display device D1, for example. The notification that the activation of the actuator is being restricted may be given through a predetermined lamp such as an indicator lamp. The notification that the activation of the actuator is being restricted may be given by an auditory method through the internal sound output device SP2 or the like, instead of or in addition to the visual method. In addition to notifying the operator inside the cabin 10 that the activation of the actuator is being restricted, the controller 30 may also notify the operator inside the cabin 10 of the reason for the restriction. That is, the controller 30 may notify the operator inside the cabin 10 that the activation of the actuator is restricted, as a function for supporting a conversation between the operator inside the cabin 10 and a person around the work machine 100.

When the process of step S126 is completed, the controller 30 ends the process of the flowchart of this time.

As illustrated in FIG. 8, in step S128, the controller 30 determines whether or not the rotational speed of the engine 11 is being restricted, according to the previous process or a process performed earlier than the previous process of this flowchart (specifically, the process of step S112). The controller 30 proceeds to step S130 when the rotational speed of the engine 11 is being restricted, and proceeds to step S134 when the rotational speed of the engine 11 is not being restricted.

In step S130, the controller 30 cancels the restriction on the rotational speed of the engine 11. For example, the controller 30 restores the rotational speed of the engine 11 from the idling rotational speed to the working rotational speed. At this time, the controller 30 restores the rotational speed of the engine 11 from the idling rotational speed to the working rotational speed, for example, with relatively slow change in the rotational speed of the engine 11.

When the process of step S130 is completed, the controller 30 proceeds to step S132.

In step S132, the controller 30 ends the notification that the rotational speed of the engine 11 is being restricted, which has started in the previous process or a process performed earlier than the previous process of the flowchart (specifically, the process of step S114). The controller 30 may end the notification that the rotational speed of the engine 11 is being restricted and may also provide a notification that the restriction on the rotational speed of the engine 11 has been cancelled.

When the process of step S132 is completed, the controller 30 ends the process of the flowchart of this time as illustrated in FIG. 7.

In step S134, the controller 30 determines whether or not the activation of the actuator is being restricted, according to the previous process or a process performed earlier than the previous process of this flowchart (specifically, the process of step S124). When the activation of the actuator is being restricted, the controller 30 proceeds to step S136, and when the activation of the actuator is not being restricted, the controller 30 ends the process of the flowchart of this time as illustrated in FIG. 7.

In step S136, the controller 30 cancels the restriction on the activation of the actuator being executed by the previous process or a process performed earlier than the previous process of this flowchart (specifically, the process of step S124). At this time, the controller 30 restores the actuator from the state where the operation of the actuator is restricted to the state where the activation of the actuator is not restricted, for example, while gradually relaxing the degrees of restriction on the activation of the actuator, and the change is relatively gradual.

For example, as illustrated in FIG. 9, the controller 30 restores the relationship between the operation amount of the operation device 26 and the operation command output to the valve 31 from the state of the graph 902 or the graph 903 to the state of the graph 901.

When the process of step S136 is completed, the controller 30 proceeds to step S138.

In step S138, the controller 30 ends the notification that the activation of the actuator is being restricted, which has started in the previous process or a process performed earlier than the previous process of this flowchart (specifically, the process of step S126). Further, the controller 30 may end the notification that the activation of the actuator is being restricted and may also perform a notification that the operation restriction of the actuator has been cancelled.

When the process of step S138 is completed, the controller 30 ends the process of the flowchart of this time as illustrated in FIG. 7.

Thus, in the present example, the controller 30 restricts the activation of the work machine 100 when a conversation is being held between the operator inside the cabin 10 and a person around the work machine 100. This enables the controller 30 to prevent noise caused by the activation of the work machine 100 (specifically, reduce the noise to be lower than when the activation is not restricted) when a conversation is being held between the operator inside the cabin 10 and the person around the work machine 100. Therefore, the controller 30 can avoid a situation in which the operator inside the cabin 10 and the person around the work machine 100 cannot communicate with each other by conversation due to noise caused by the activation of the work machine 100.

### [Second Example of Conversation Support Process]

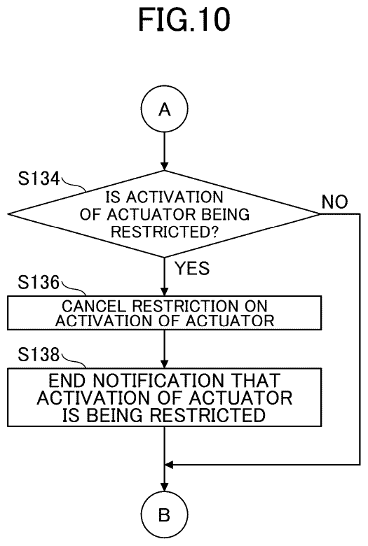

Next, a second example of a conversation support process will be described with reference to FIG. 10.

FIG. 10 is a flowchart schematically illustrating a second example of the conversation support process.

The present example is different from the first example (FIGS. 7 and 8) in that the processes of steps S128 to S132 are omitted. In the following, in this example, the processing part corresponding to the above-described FIG. 7 in the conversation support process is not changed, and thus FIG. 7 is used.

The processes of steps S102 to S106 are the same as those of the first example described above, and thus the description thereof will be omitted.

In step S106, the controller 30 proceeds to step S108 when a conversation is being held between the operator inside the cabin 10 and the person around the work machine 100, and proceeds to step S134 as illustrated in FIG. 10 when the conversation is not being held.

The processes of steps S108 to S126 are the same as those of the first example described above, and thus the description thereof will be omitted.

The processes of steps S134 to S138 are the same as those of the first example described above, and thus the description thereof will be omitted.

In this way, in the present example, the processes of steps S128 to S132 of the first example described above are omitted. Thus, even if the controller 30 shifts to a situation where a conversation is no longer being held between the operator inside the cabin 10 and the person around the work machine 100 during the restriction on the rotational speed of the engine 11, the controller 30 can continue restricting the rotational speed of the engine 11 until the operation of the operation device 26 is started. Therefore, for example, when the conversation between the operator inside the cabin 10 and the person around the work machine 100 is interrupted due to breathing or the like, the controller 30 can avoid a situation in which the rotational speed of the engine 11 increases and communication is hindered when the conversation is restarted thereafter.

### [Third Example of Conversation Support Process]

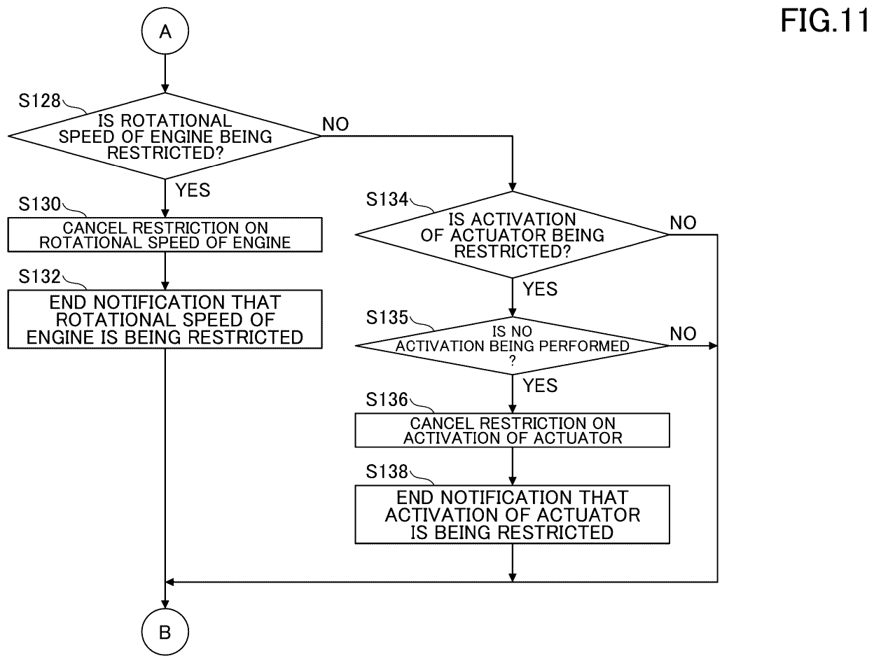

Next, a third example of the conversation support process will be described with reference to FIG. 11.

FIG. 11 is a flowchart schematically illustrating a third example of a conversation support process.

The present example is different from the first example (FIGS. 7 and 8) in that a step S135 is added. In the following, in this example, the processing part corresponding to the above-described FIG. 7 in the conversation support process is not changed, and thus FIG. 7 is used.

The processes of steps S102 to S134 are the same as those of the first example described above, and thus the description thereof will be omitted.

In step S134, when the activation of the actuator is being restricted, the controller 30 proceeds to step S135, and when the activation of the actuator is not being restricted, the controller 30 ends the process of the flowchart of this time as illustrated in FIG. 7.

In step S135, the controller 30 determines whether or not the operation of the actuator (i.e., the driven part) is being performed by the operator inside the cabin 10. When the actuator is not operated by the operator inside the cabin 10, the controller 30 proceeds to step S136, and when the actuator is operated, the controller 30 ends the process of the flowchart of this time as illustrated in FIG. 7.

The processes of steps S136 and S138 are the same as those of the first example described above, and thus the description thereof will be omitted.

Thus, in the present example, the controller 30 cancels the restriction on the activation of the actuator when no conversation is being held between the operator inside the cabin 10 and the person around the work machine 100, and the actuator is not operated by the operator inside the cabin 10. Thus, even when the conversation between the operator inside the cabin 10 and the person around the work machine 100 ends, the controller 30 can continue the restriction on the activation of the actuator until the operation of the actuator ends (e.g., until the operation lever included in the operation device 26 returns to the neutral position). Therefore, the controller 30 can avoid a situation in which the activation speed of the actuator increases due to the cancellation of the restriction on the activation of the actuator during the operation of the actuator, and the operator feels discomfort.

### [Fourth Example of Conversation Support Process]

Next, a fourth example of a conversation support process will be described with reference to FIGS. 7 and 11.

In this example, the second example and the third example of the conversation support process described above are combined.

Specifically, in the present example, the conversation support process is implemented by the flowchart of FIG. 7 and the flowchart of FIG. 11 from which steps S128 to S132 are omitted. Thus, the same operation and effect as those of the second and third examples described above are achieved.

### [Fifth Example of Conversation Support Process]

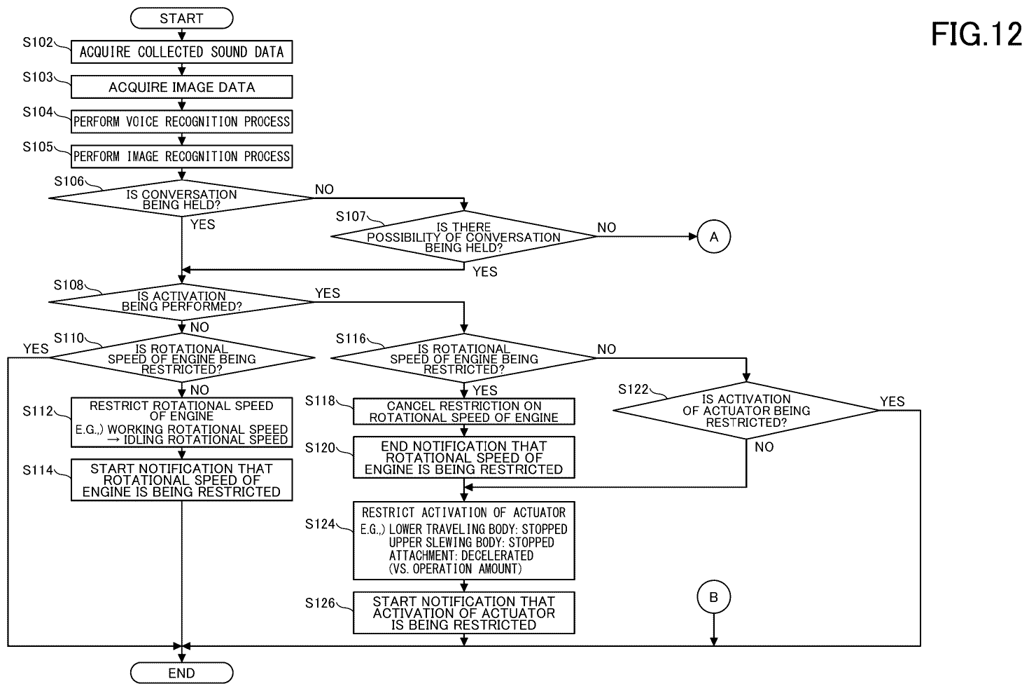

Next, a fifth example of a conversation support process will be described with reference to FIG. 12.

FIG. 12 is a flowchart schematically illustrating the fifth example of the conversation support process.

The present example is different from the first to fourth examples described above in that steps S103, S105, and S107 are added, and may be the same as any one of the first to fourth examples described above in other respects. Hereinafter, in the present example, the processes of the first to fourth examples described above are applied to the processes other than steps S102 to S126 in the conversation support process.

As illustrated in FIG. 12, the process of step S102 is the same as that of the first to fourth examples described above, and thus the description thereof will be omitted.

When the process of step S102 is completed, the controller 30 proceeds to step S103.

In step S103, the controller 30 acquires the latest image (image data) output from the imaging device S6.

When the process of step S103 is completed, the controller 30 proceeds to step S104.

The process of step S104 is the same as that of the first to fourth examples described above, and thus the description thereof will be omitted.

When the process of step S104 is completed, the controller 30 proceeds to step S105.

In step S105, the controller 30 performs a known image recognition process for recognizing a person around the work machine 100 based on the image data acquired in step S103.

When the process of step S105 is completed, the controller 30 proceeds to step S106.

The process of step S106 is the same as that of the first to fourth examples described above, and thus the description thereof will be omitted.

In step S106, the controller 30 proceeds to step S107 when a conversation is not being held between the operator inside the cabin 10 and the person around the work machine 100, and proceeds to step S108 when the conversation is being held.

In step S107, the controller 30 determines whether or not there is a possibility of a conversation being held between the operator inside the cabin 10 and the person around the work machine 100, based on the result of the image recognition process in step S105.

For example, when a person is recognized by the image recognition process within a predetermined range with reference to the work machine 100 and the person stands so as to face the work machine 100, the controller 30 determines that there is a possibility of a conversation being held between an operator and the person around the work machine 100. Further, when a person is recognized by the image recognition process within the predetermined range with reference to the work machine 100 and the person is moving toward the work machine 100, the controller 30 may determine that there is a possibility of a conversation being held between the operator and the person around the work machine 100. Further, the controller 30 may attempt to recognize a predetermined gesture of a person based on image data of the person recognized by the image recognition process, and when the predetermined gesture is recognized, the controller 30 may determine that there is a possibility of a conversation being held between an operator and the person around the work machine 100. The predetermined gesture is a gesture for communicating with the operator inside the cabin 10. The controller 30 may use a machine learning-based discriminator that receives image data of a person recognized by image recognition process or data representing features of the image data as an input and discriminates whether the recognized person is likely to have a conversation. Thus, the controller 30 can comprehensively evaluate, for example, a facial expression, behavior (e.g., gesture), and the like of a person in the image by using the discriminator, and determine whether or not there is a possibility of a conversation being held between an operator and a person around the work machine 100. The data representing the features of the recognized image data of a person is, for example, the data of local features of the image data. The discriminator is mainly configured by, for example, a deep neural network (DNN). The discriminator is obtained by performing supervised learning on the basic training model based on the training data set. The discriminator may be obtained by performing additional training or retraining on a trained model that has been trained based on the training data set. At this time, for example, the algorithm of the backpropagation is applied based on the output error with the training data, and thus the discriminator as the trained model is optimized. The trained model corresponding to the discriminator is distributed from, for example, a predetermined external device (e.g., the management device 200 to be described later) and installed in the controller 30. The discriminator may be, for example, a support vector machine (SVM).

The controller 30 proceeds to step S108 when there is a possibility of a conversation being held between the operator inside the cabin 10 and a person around the work machine 100. On the other hand, when there is no possibility that a conversation will be held between the operator inside the cabin 10 and a person around the work machine 100, the controller 30 proceeds to step S128 as illustrated in FIG. 8 or 11, or to step S134 as illustrated in FIG. 10.

The processes after step S108 are the same as those of the first to fourth examples described above.

Thus, in the present example, the controller 30 restricts the activation of the work machine 100 when there is a possibility of a conversation being held between the operator inside the cabin 10 and the worker around the work machine 100. Thus, the controller 30 can prevent the noise caused by the activation of the work machine 100 (specifically, reduce the noise to be lower than when the activation is not restricted) before the start of the conversation. Therefore, the controller 30 can more appropriately avoid a situation in which the operator inside the cabin 10 and the person around the work machine 100 cannot communicate with each other by conversation due to noise caused by the activation of the work machine 100.

In this example, even when there is no conversation between the operator inside the cabin 10 and the person around the work machine 100, the controller 30 can continue restricting the activation of the work machine 100 when there is a possibility of conversation. This enables the controller 30 to continue restricting the activation of the work machine 100 and maintain noise caused by the activation of the work machine 100 to be relatively low, even in situations where, for example, the two parties have a relatively short pause for thought during the conversation and then the conversation is restarted. Therefore, the controller 30 can more appropriately avoid a situation in which the operator inside the cabin 10 and the person around the work machine 100 cannot communicate with each other by conversation due to noise caused by the activation of the work machine 100.

### [Other Examples of Conversation Support Process]

Next, another example of the conversation support process will be described.

The first to fifth examples of the conversation support process described above may be modified or altered as appropriate.

For example, in step S124 of the first to fifth examples of the conversation support process described above, the controller 30 may decelerate the activation of the actuator corresponding to the upper slewing body 3 with respect to the operation amount of the operation device 26 to a certain speed (e.g., the state of the graph 902 of FIG. 9).

In addition, in step S124 of the first to fifth examples of the conversation support process, and modifications or alterations thereof, the controller 30 may set, as actuators subject to activation restriction, only a part of the actuators that cause a relatively large effect of noise, from among all the actuators that drive the driven parts.

In step S124 of the first to fifth examples of the conversation support process, and modifications or alterations thereof, the controller 30 may decelerate the activation of each of all the actuators subject to the activation restriction, with respect to the operation amount of the operation device 26 to a certain speed (e.g., the state of the graph 902 in FIG. 9).

In step S124 of the first to fifth examples of the conversation support process, and the modifications or alterations thereof, the controller 30 may stop the activation of each of the actuators subject to activation restriction, independent of the operation state of those actuators (e.g., the state of the graph 903 in FIG. 9).

In step S106 of the first to fifth examples of the conversation support process, and the modifications or alterations thereof, the controller 30 may determine whether or not a conversation is being held between the operator and a person around the work machine 100 based on other information instead of or in addition to the result of the voice recognition process.

For example, the controller 30 may recognize a person around the work machine 100 based on the image data captured by the imaging device S6, and determine that a conversation is being held between the operator and the person around the work machine 100 when the person is speaking at the work machine 100. Further, in a situation where a conversation is being held between the operator and the person around the work machine 100, the controller 30 may determine that a conversation is no longer being held between the operator and the person around the work machine 100 when the person is no longer recognized within a predetermined range with reference to the work machine 100. Further, the controller 30 may determine that a conversation is no longer being held between the operator and the person around the work machine 100 when the state of the speech button KS is changed from an operated state to a non-operated state.

Further, in step S107 of the fifth example of the conversation support process, and modifications or alterations thereof, the controller 30 may determine whether or not there is a possibility of a conversation being held between the operator and the person around the work machine 100, based on other information instead of or in addition to the image data of the imaging device S6.

For example, an indoor camera capable of capturing an image of the state of the inside of the cabin 10 including the operator is provided inside the cabin 10, and the controller 30 determines whether or not there is a possibility of a conversation being held between the operator and a person around the work machine 100, based on image data of the indoor camera.

### [Another Configuration Example of Work Machine]

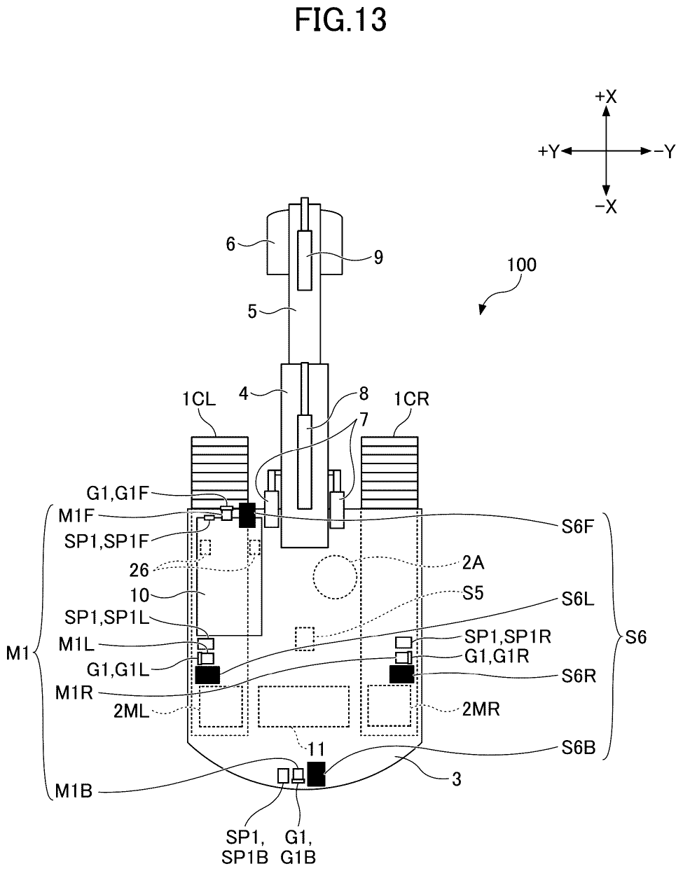

Next, another configuration example of the work machine 100 will be described with reference to FIG. 13. FIG. 13 is a top view illustrating another example of a configuration of the work machine 100. The work machine 100 illustrated in FIG. 13 is different from the work machine 100 illustrated in FIGS. 1 and 2 in that the external sound output device SP1 is constituted by four speakers (a front speaker SP1F, a left speaker SP1L, a right speaker SP1R, and a rear speaker SP1B). In the work machine 100 illustrated in FIGS. 1 and 2, the external sound output device SP1 is configured by one omnidirectional speaker provided on the cabin 10.

With this configuration, the work machine 100 illustrated in FIG. 13 can output sound toward the worker WK in front of the work machine 100 without outputting sound toward the workers WK on the left, right, and rear of the work machine 100 by turning on the front speaker SP1F (a state in which sound can be output) and turning off the left speaker SP1L, the right speaker SP1R, and the rear speaker SP1B (a state in which sound cannot be output), for example.

In the example illustrated in FIG. 13, the front camera S6F and the front microphone M1F are provided adjacent to the front speaker SP1F, and a front light bar G1F is provided in a housing of the front microphone M1F. Further, a left camera S6L and a left microphone M1L are provided adjacent to the left speaker SP1L, and a left light bar G1L is provided in a housing of the left microphone M1L. Further, the right camera S6R and the right microphone M1R are provided adjacent to the right speaker SP1R, and a right light bar G1R is provided in a housing of the right microphone M1R. Further, the rear camera S6B and the rear microphone M1B are provided adjacent to the rear speaker SP1B, and the rear light bar G1B is provided in a housing of the rear microphone M1B.

With this configuration, the work machine 100 can turn on the light bar corresponding to the speaker that has been turned on (light emittable state), and turn off the light bar corresponding to the speaker that has been turned off (light non-emittable state).

The external sound output device SP1 may be configured by one or a plurality of parametric speakers. The parametric speakers are ultrasonic speakers that can selectively transmit sound to a person in a specific narrow range. The parametric speakers can transmit sound toward any location.

In the work machine 100 illustrated in FIG. 13, the controller 30 may detect the worker WK around the work machine 100 based on the image data captured by the imaging device S6 and specify the position of the worker WK. Further, when a plurality of workers WK are present around the work machine 100, the controller 30 may discriminate between a conversation target person (a worker WK who is uttering voice) and a non-target person (a worker WK who is not uttering voice) based on the outputs of the four external sound collection devices M1. The controller 30 may distinguish between a conversation partner (the worker WK facing the work machine 100) and a non-partner (the worker WK not facing the work machine 100) based on the image data captured by the imaging device S6. Then, the controller 30 may turn on the speaker and the light bar facing the worker WK. For example, when the worker WK (uttering voice) is present behind the work machine 100, the controller 30 may turn on the rear speaker SP1F while keeping the front speaker SP1L, the left speaker SP1R, and the right speaker SP1B turned off. In this case, the controller 30 may turn on the rear light bar G1B while keeping the front light bar G1F, the left light bar G1L, and the right light bar G1R turned off. Such a function may be implemented in the work machine 100 illustrated in FIGS. 1 to 5.

With this configuration, the controller 30 can output sound in the direction in which the worker WK is present without outputting a sound in the direction in which the worker WK is absent. Therefore, the worker WK can easily recognize whether he/she is considered a target or a non-target for the conversation.

### [Configuration of Operation Support System]

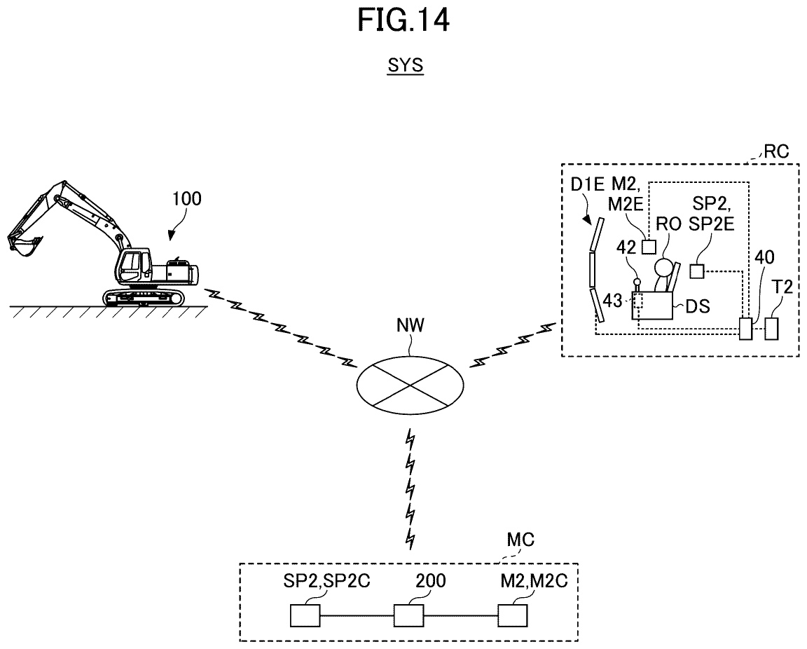

Next, a configuration example of an operation support system SYS according to the embodiment of the present disclosure will be described with reference to FIG. 14. FIG. 14 is a schematic view illustrating a configuration example of the operation support system SYS. As illustrated in FIG. 14, the operation support system SYS includes the work machine 100, a remote operation room RC, and a management center MC. Note that a detailed configuration of the work machine 100 is omitted from illustration in FIG. 14. This is because the work machine 100 illustrated in FIG. 14 has the same configuration as the work machine 100 illustrated in FIG. 1 or FIG. 13.

The work machine 100, the remote control room RC, and the management center MC are connected to each other via a communication network NW so as to be able to transmit and receive data. The work machine 100, the remote control room RC, and the management center MC may be connected to each other so as to be able to directly transmit and receive data to and from each other without allowing the data to pass through the communication network NW. In the illustrated example, the work machine 100 transmits information about the work site to the remote control room RC. Thus, a remote operator RO in the remote operation room RC can grasp the situation of the work site based on the information from the work machine 100.

The work machine 100 is provided with sensors capable of three dimensionally recognizing positions and shapes of objects existing in the work site. For example, the work machine 100 is provided with a space recognition device. Therefore, the work machine 100 can transmit a result of three dimensionally measuring the work site to the remote control room RC.

The space recognition device is a device for recognizing a space around the work machine 100. In the illustrated example, the space recognition device is a LiDAR. The LiDAR measures, for example, a distance between the LiDAR and each of one million or more points within a monitoring range. The space recognition device may be any device capable of measuring the distance to an object. For example, the space recognition device may be a stereo camera, or may be a combination of the imaging device S6 and a distance measuring device such as a millimeter wave radar.

The number of work machines 100 included in the operation support system SYS may be one or more. In the case where a plurality of work machines 100 are included, the remote operator RO of a specific work machine 100 can acquire information about the work site acquired by the specific work machine 100 and information about the work site acquired by one or more other work machines 100.

The remote control room RC is provided with a communication device T2, a remote controller 40, an operation device 42, an operation sensor 43, a display device D1E, an internal sound collection device M2E, and an internal sound output device SP2E. In addition, an operation seat DS on which the remote operator RO who remotely operates the work machine 100 sits is installed in the remote operation room RC.

The communication device T2 is configured to be able to communicate with the communication device T1 attached to the work machine 100.

The remote controller 40 is a computing device that executes various computations. In the present embodiment, the remote controller 40 is configured by a microcomputer including a CPU and a memory. The various functions of the remote controller 40 are implemented by the CPU executing the programs stored in the memory.

The display device D1E is a device capable of displaying various kinds of information. The display device D1E displays an image based on information transmitted from the work machine 100 in order for the remote operator RO in the remote control room RC to visually recognize the surroundings of the work machine 100. In the illustrated example, the display device D1E is a liquid-crystal display that displays an image data captured by the imaging device S6 mounted on the work machine 100. The display device D1E may be a display or a projector that implements naked-eye stereoscopic vision, or VR (Virtual Reality) goggles or the like may be used.

The internal sound output device SP2E is a device capable of outputting various kinds of sound information. The internal sound output device SP2E outputs sound based on information transmitted from the work machine 100 so that the remote operator RO in the remote control room RC can hear sound generated at the work site. The internal sound output device SP2E may be configured to output sound captured by the external sound collection device M1 attached to the outside of the cabin 10, or may be configured to output sound captured by the internal sound collection device M2 attached to the inside of the cabin 10, for example. In this case, the internal sound collection device M2 may be provided at a position corresponding to the position of the ears of the operator seated on the operator's seat 50 in the cabin 10. The internal sound output device SP2E may be a stationary device such as a speaker, or may be a wearable device such as an earphone or a headphone. The speaker may be a monaural speaker, a stereo speaker, or a surround speaker. The speaker may be an omnidirectional speaker or a directional speaker. The wearable device may have a noise canceling function, a spatial audio function (stereophonic function), or a bone conduction function.

The operation device 42 is provided with the operation sensor 43 for detecting the operation content of the operation device 42. The operation sensor 43 is, for example, an inclination sensor that detects an inclination angle of the operation lever, an angle sensor that detects a slewing angle of the operation lever around a slewing axis, or the like. The operation sensor 43 may be configured by another sensor such as a pressure sensor, a current sensor, a voltage sensor, or a distance sensor. The operation sensor 43 outputs information about the detected operation content of the operation device 42 to the remote controller 40. The remote controller 40 generates an operation signal based on the received information, and transmits the generated operation signal to the work machine 100. The operation sensor 43 may be configured to generate the operation signal. In this case, the operation sensor 43 may output the operation signal to the communication device T2 without passing through the remote controller 40. With such a configuration, the remote operator RO can remotely operate the work machine 100 from the remote operation room RC.

In the present example, a conversation function between the remote operator RO inside the remote operation room RC and a person around the work machine 100 (hereinafter, referred to as a “remote conversation function” for convenience) is implemented by the above-described configuration.

For example, the remote control room RC is provided with an operation tool having the same function as the switch SW and the speech button KS provided in the cabin 10.

Further, the conversation support process similar to the above-described process may be executed for the remote conversation function. In this case, in the conversation support process described above, the “operator”, the “cabin 10”, the “operation device 26”, the “internal sound collection device M2”, and the “internal sound output device SP2” are replaced with the “remote operator RO”, the “remote operation room RC”, the “operation device 42”, the “internal sound collection device M2E”, and the “internal sound output device SP2E”, respectively. In this case, some of the processes included in the conversation support process may be executed by the remote controller 40 in coordination with the controller 30.

The management center MC is a facility in which various devices for managing the work machines 100 at respective work sites or the remote operation of the work machine 100 by the remote operator RO in the remote operation room RC are provided. In the illustrated example, the management center MC is installed at a position away from the work site of the work machine 100 or the remote control room RC. The management center MC is provided with a management device 200, an internal sound collection device M2C, and an internal sound output device SP2C.

The management device 200 is, for example, a server device. The server device may be a so-called on-premise server or cloud server, or may be an edge server. The management device 200 may be a terminal device. The terminal device may be a stationary terminal device or a portable terminal device (e.g., a laptop computer, a tablet, or a smartphone).

With this configuration, a manager in the management center MC can hear the sound generated at the work site by using the sound collection device (the external sound collection device M1 or the internal sound collection device M2) attached to the work machine 100 and the internal sound output device SP2C, for example. The manager in the management center MC can hear the sound generated in the remote control room RC by using the internal sound collection device M2E and the internal sound output device SP2C provided in the remote control room RC, for example. Further, the manager at the management center MC can transmit his or her voice to the worker WK around the work machine 100 by using, for example, the internal sound collection device M2C and the external sound output device SP1 attached to the work machine 100. The manager at the management center MC can also use the internal sound collection device M2C and the internal sound output device SP2 attached to the work machine 100 to transmit his or her voice to the operator OP of the work machine 100. The manager in the management center MC can transmit his or her voice to the remote operator RO in the remote control room RC by using the internal sound collection device M2C and the internal sound output device SP2E provided in the remote control room RC.

In the present example, the same conversation support process as described above may be executed for the conversation function between the manager of the management center MC and the person around the work machine 100. In this case, a part of the conversation support process may be executed by the management device 200 in coordination with the controller 30. Similarly, in the present example, the conversation support process similar to the above-described conversation support process may be executed for the conversation function between the manager of the management center MC and the operator inside the cabin 10 of the work machine 100. In this case, a part of the conversation support process may be executed by the management device 200 in coordination with the controller 30. Similarly, in the present example, the conversation support process similar to the above-described conversation support process may be executed for the conversation function between the manager of the management center MC and the remote operator RO inside the remote operation room RC. In this case, the conversation support process may be executed by at least one of the remote controller 40 and the management device 200 in coordination with the controller 30.

### Effect

Next, the effect of the work machine and the operation support system according to the present embodiment will be described.

In a first aspect of the present embodiment, a work machine includes a lower traveling body, an upper slewing body, a cabin, an acquisition device, and a control device. The work machine is, for example, the work machine 100 described above. The lower traveling body is, for example, the lower traveling body 1 described above. The upper slewing body is, for example, the upper slewing body 3 described above. The cabin is, for example, the cabin 10 described above. The acquisition device is, for example, the external sound collection device M1, the internal sound collection device M2, the imaging device S6, the speech button KS, or the like. The control device is, for example, the controller 30 described above. Specifically, the upper slewing body is slewably mounted on the lower traveling body. The cabin is provided in the upper slewing body, and boarded by an operator of the work machine. The acquisition device acquires information about a situation of a conversation between an operator and a person around the work machine. The control device receives an output of the acquisition device. The control device restricts activation of the work machine when a conversation is being held between the operator and the person around the work machine.

This enables the control device to prevent noise caused by the activation of the work machine (specifically, reduce the noise to be lower than when the activation is not restricted) when a conversation is being held between the operator inside the cabin and the person around the work machine. Therefore, the control device can avoid a situation in which noise from the activation of the work machine disturbs the two parties from appropriately communicating with each other. Therefore, the control device can support communication between the operator of the work machine and the person around the work machine.

In a second aspect of the present embodiment, according to the first aspect described above, the control device may restrict at least one of a rotational speed of an engine, activation of the lower traveling body, activation of the upper slewing body, or activation of an attachment attached to the upper slewing body when a conversation is being held between an operator and a person around the work machine. The engine is, for example, the engine 11 described above. The attachment is, for example, the attachment AT described above.

This enables the control device to inhibit noise caused by the activation of the engine and the activation of the driven parts driven by the actuators such as the lower traveling body, the upper slewing body, and the attachment when a conversation is being held between the operator inside the cabin and the person around the work machine.

In a third aspect of the present embodiment, according to the first or second aspect described above, the control device may cancel the restriction on the activation of the work machine when the information acquired by the acquisition device is shifted from a state representing that a conversation is being held between the operator and the person around the work machine to a state representing that a conversation is no longer being held.

This enables the control device to cancel the restriction on the activation of the work machine when the conversation is no longer being held between the operator inside the cabin and the person around the work machine.

In a fourth aspect of the present embodiment, according to the third aspect described above, the acquisition device may be a predetermined operation input device provided inside the cabin, and the control device may restrict the activation of the work machine when the predetermined operation input device is operated, and may cancel the restriction on the activation of the work machine when the predetermined operation input device is shifted from an operated state to a non-operated state. The predetermined operation input device is, for example, the above-described speech button KS. The acquisition device may be an imaging device provided on the upper slewing body or inside the cabin and configured to acquire information about an object around the work machine, and the control device may restrict the activation of the work machine when a person is detected in a predetermined range around the work machine based on the information of the imaging device, and may cancel the restriction on the activation of the work machine when the person is no longer detected in the predetermined range around the work machine based on the information of the imaging device. The acquisition device may be a sound collection device configured to collect sound inside the cabin or around the work machine, and the control device may restrict the activation of the work machine when a human voice is recognized based on an output of the sound collection device, and may cancel the restriction on the activation of the work machine when the human voice is no longer recognized based on an output of the sound collection device. The sound collection device is, for example, the external sound collection device M1 or the internal sound collection device M2 described above.

Thus, the control device can cancel the restriction on the activation of the work machine when the conversation is no longer being held between the operator inside the cabin and the person around the work machine.

In a fifth aspect of the present embodiment, according to any one of the first to fourth aspects described above, the control device may restrict the activation of the work machine when there is a possibility that a conversation is being held between the operator and the person around the work machine.

This enables the control device to reduce noise caused by activation of the work machine in advance when there is a possibility of a conversation being held between the operator inside the cabin and the person around the work machine, for example. Therefore, the control device can more appropriately avoid a situation in which the noise caused by the activation of the work machine disturbs the two parties from appropriately communicating with each other.

In a sixth aspect of the present embodiment, according to any one of the first to fifth aspects described above, the work machine may include an internal sound collection device configured to collect sound inside the cabin, and an external sound output device provided outside the cabin and configured to output the sound collected by the internal sound collection device toward the surroundings of the work machine.

Thus, the work machine can deliver a voice of a person inside the operator's seat to a person around the work machine at an appropriate volume by the external sound output device. Therefore, the work machine can support communication between the operator inside the cabin and a person around the work machine.

In a seventh aspect of the present embodiment, according to the sixth aspect described above, the external sound output device may output sound collected by the internal sound collection device toward the surroundings of the work machine when a predetermined operation input device provided inside the cabin is operated. The predetermined operation input device is, for example, the above-described speech button KS.

Thus, the operator inside the cabin can deliver a content of his or her utterance to a person around the work machine in accordance with the timing at which the operator desires to have a conversation.

In an eighth aspect of the present embodiment, according to any one of the first to seventh aspects described above, the work machine may include a notification device provided inside the cabin and configured to notify the operator of the restriction when the activation of the work machine is restricted by the control device. The notification device is, for example, the display device D1 or the internal sound device SP2 described above.

Thus, when the activation of the work machine itself is restricted, the work machine can notify the operator inside the cabin of the restriction.

In a ninth aspect of the present embodiment, according to the second aspect described above, the control device may stop activation of at least one of the upper slewing body or the lower traveling body or maintain the activation in a stopped state when a conversation is being held between the operator and the person around the work machine, and may reduce the speed of the activation of the attachment with respect to the operation compared to the speed of the activation of the attachment when a conversation is no longer being held between the operator and the person around the work machine.

Thus, the control device can restrict the activation of the lower traveling body, the upper slewing body, and the attachment and prevent noise caused by the activation of these parts when a conversation is being held between the operator inside the cabin and the person around the work machine.

In a tenth aspect of the present embodiment, according to the second or ninth aspect described above, when a conversation is being held between the operator and the person around the work machine in a situation where an operation of an actuator for driving a driven part of the work machine is not performed by the operator, the control device may restrict the rotational speed of the engine, and subsequently when the conversation is no longer being held between the operator and the person around the work machine in a situation where the operation of the actuator is not performed by the operator, the control device may continue restricting the rotational speed of the engine in a period from an end of the conversation until starting performing of the operation of the actuator.

Thus, when a conversation is started between the operator and the person around the work machine in a situation where an operation of the actuator of the work machine is not performed, the control device can continue restricting the rotational speed of the engine unless the operation of the actuator of the work machine is started thereafter. Therefore, the control device can more appropriately support communication between the operator inside the cabin and the person around the work machine in a situation where, for example, a conversation is temporarily interrupted and immediately restarted.

In an eleventh aspect of the present embodiment, according to the second, ninth, or tenth aspect described above, when a conversation is being held between the operator and the person around the work machine, the control device may restrict activation of at least one of the lower traveling body, the upper slewing body, or the attachment, and subsequently when the conversation is no longer being held between the operator and the person around the work machine, the control device may continue restricting the activation in a period from an end of the conversation until ending performing of an operation of at least one of the lower traveling body, the upper slewing body, or the attachment whose activation is restricted.

This enables the control device to prevent a situation in which, for example, when operating a driven part such as the lower traveling body, the upper slewing body, or the attachment, the speed of the activation of the driven part increases due to the cancellation of restriction on the activation, causing the operator to feel discomfort.

In a twelfth aspect of the present embodiment, an operation support system enables a conversation between an operator who performs a remote operation of a work machine including a lower traveling body and an upper slewing body slewably mounted on the lower traveling body and a person around the work machine. The operation support system is, for example, the above-described operation support system SYS. The lower traveling body is, for example, the lower traveling body 1 described above. The upper slewing body is, for example, the upper slewing body 3 described above. The operator is, for example, the remote operator RO described above. Specifically, the operation support system may include an acquisition device configured to acquire information related to a situation of a conversation between the operator and a person around the work machine, and a control device configured to receive an output of the acquisition device. The acquisition device is, for example, the external sound collection device M1, the internal sound collection device M2E, the imaging device S6, or a speech button provided in the remote control room RC. The control device is, for example, the controller 30 or the remote controller 40 described above. The control device restricts the activation of the work machine when a conversation is being held between the operator and a person around the work machine.

This enables the operation support system to prevent noise caused by the activation of the work machine (specifically, reduce the noise to be lower than when the activation is not restricted) when a conversation is being held between an operator who performs remote operation of the work machine and a person around the work machine. Therefore, the operation support system can avoid a situation in which the noise caused by the activation of the work machine disturbs the two parties from appropriately communicating with each other. Therefore, the operation support system can support communication between the operator who performs remote operation of the work machine and the person around the work machine.

The preferred embodiments of the present disclosure have been described above. However, the invention according to the present disclosure is not restricted to the above-described embodiments. Various modifications, substitutions, and the like can be applied to the above-described embodiments without departing from the scope of the invention according to the present disclosure. Further, the features described with reference to the above-described embodiments may be appropriately combined as long as there is no technical contradiction.

What is claimed is:

1. A work machine comprising:
a lower traveling body;
an upper slewing body slewably mounted on the lower traveling body;
a cabin mounted on the upper slewing body and configured to be boarded by an operator of a work machine; and
a processor, and a memory storing instructions that cause the processor to execute a process, wherein the process includes
acquiring, from a speech button, a camera, or a microphone, information related to a situation of a conversation between the operator and a person around the work machine; and
receiving an output of the speech button, the camera, or the microphone,
wherein the receiving includes restricting activation of the work machine when a conversation is being held between the operator and the person around the work machine.

2. The work machine according to claim 1,
wherein the receiving includes restricting at least one of a rotational speed of an engine, activation of the lower traveling body, activation of the upper slewing body, or activation of an attachment attached to the upper slewing body when a conversation is being held between the operator and the person around the work machine.

3. The work machine according to claim 1,
wherein the receiving includes cancelling the restriction on the activation of the work machine when the information acquired by the speech button, the camera, or the microphone is shifted from a state representing that a conversation is being held between the operator and the person around the work machine to a state representing that a conversation is no longer being held between the operator and the person around the work machine.

4. The work machine according to claim 3,
wherein the speech button is provided inside the cabin, and the receiving includes restricting the activation of the work machine when the speech button is operated and cancelling the restriction on the activation of the work machine when the speech button is shifted from an operated state to a non-operated state,
wherein the camera is provided on the upper slewing body or inside the cabin and configured to acquire information about an object around the work machine, and the receiving includes restricting the activation of the work machine when a person is detected in a predetermined range around the work machine based on the information of the camera and cancelling the restriction on the activation of the work machine when the person is no longer detected in the predetermined range around the work machine based on the information of the camera, or
wherein the microphone is configured to collect sound inside the cabin or sound around the work machine, and the receiving includes restricting the activation of the work machine when a voice of a person is recognized based on an output of the microphone and cancelling the restriction on the activation of the work machine when the voice of the person is no longer recognized based on the output of the microphone.

5. The work machine according to claim 1,
wherein the receiving includes restricting the activation of the work machine when there is a possibility that a conversation is being held between the operator and the person around the work machine.

6. The work machine according to claim 1, further comprising:
an internal microphone configured to collect sound inside the cabin; and
an external speaker provided outside the cabin and configured to output the sound collected by the internal microphone toward surroundings of the work machine.

7. The work machine according to claim 6,
wherein the external speaker outputs the sound collected by the internal microphone toward the surroundings of the work machine when the speech button provided inside the cabin is operated.

8. The work machine according to claim 1, further comprising:
a display device or a speaker provided inside the cabin, the display device or the speaker notifying the operator that the activation of the work machine is restricted.

9. The work machine according to claim 2,
wherein the receiving includes stopping activation of at least one of the upper slewing body or the lower traveling body, or maintaining the activation in a stopped state when a conversation is being held between the operator and the person around the work machine, and reducing the speed of the activation of the attachment with respect to an operation compared to when the conversation is not being held between the operator and the person around the work machine.

10. The work machine according to claim 2,
wherein when a conversation is being held between the operator and the person around the work machine in a situation where an operation of an actuator for driving the upper slewing body or the lower traveling body of the work machine is not being performed, the receiving includes restricting the rotational speed of the engine, and subsequently when the conversation is no longer being held between the operator and the person around the work machine in a situation where the operation of the actuator is not being performed, the receiving includes continuing restricting the rotational speed of the engine in a period from an end of the conversation until starting performing of the operation of the actuator.

11. The work machine according to claim 2,
wherein when a conversation is being held between the operator and the person around the work machine, the receiving includes restricting activation of at least one of the lower traveling body, the upper slewing body, or the attachment, and subsequently when the conversation is no longer being held between the operator and the person around the work machine, the receiving includes continuing restricting the activation in a period from an end of the conversation until ending performing of an operation of the at least one of the lower traveling body, the upper slewing body, or the attachment, the activation of the lower traveling body, the upper slewing body, or the attachment being restricted.

12. An operation support system enabling a conversation between an operator who performs remote control of a work machine and a person around the work machine, the work machine including a lower traveling body and an upper slewing body slewably mounted on the lower traveling body, the operation support system comprising:
a processor, and a memory storing instructions that cause the processor to execute a process, wherein the process includes
acquiring, from a speech button, a camera, or a microphone, information related to a situation of a conversation between the operator and the person around the work machine; and
receiving an output of the speech button, the camera, or the microphone,
wherein the receiving includes restricting activation of the work machine when a conversation is being held between the operator and the person around the work machine.
